(19) United States
(12) Patent Application Publication
(10) Pub. No.: US 2020/0211045 A1
(43) Pub. Date: Jul. 2, 2020

(54) FRACTIONAL FUND TRANSFER AND ACCUMULATION SYSTEM

(71) Applicant: Nomura Research Institute, Ltd., Tokyo (JP)

(72) Inventor: Tatsuo TANAKA, Tokyo (JP)

(73) Assignee: Nomura Research Institute, Ltd., Tokyo (JP)

(21) Appl. No.: 16/615,039

(22) PCT Filed: May 23, 2018
(86) PCT No.: PCT/JP2018/019821

§ 371 Date: Nov. 19, 2019

(30) Foreign Application Priority Data
Jun. 1, 2017 (JP) 2017-109418

(51) Int. Cl. G06Q 30/02; G06Q 40/02; G06Q 20/28; G06Q 20/34

(52) U.S. Cl. CPC G06Q 30/0215; G06Q 20/342; G06Q 20/28; G06Q 40/02

(57) ABSTRACT

A predetermined fractional amount is computed on the basis of user's daily payment or the like, and is transferred as a reserving amount to a target amount to assist, for example, a user's reserve or asset building.

### TECHNICAL FIELD

The present invention relates to a technology of assisting, for example, user's reserving or asset building, and particularly relates to a fractional fund transfer and accumulation system effective in causing a user to effortlessly reserve a target fund for purchase of, for example, a desired product or service.

### BACKGROUND ART

In general, in a case where a user purchases a desired product or service, such as a financial product, a trip, or a daily commodity, the user needs to save a fund therefor.

Therefore, efficient building and reserving of a purchase fund and a target amount for purchase of a desired product or service is an important issue to the user.

In order to build such a fund for purchase of a product or service by reserving, in general, for example, a certain amount of money is monthly allocated to reserving, with suppression and economization of daily spending.

Although suppression and economization of daily spending are desirable, vague suppression of spending is actually difficult to perform as long as, for example, no specific numerical target is set. Thus, simply “reducing and economizing spending” is insufficient for achievement of reserving of a target amount.

Meanwhile, monthly reserving of a certain amount of money means that cumulation is performed by automatic deduction with, for example, a cumulative deposit, so that a target amount can be reliably reserved.

However, compulsory monthly allocation of a certain amount of money to reserving causes cumulation itself to be difficult to perform, depending on the income and expenditure of the user, for example, when unexpected expenses are repeated. Thus, not infrequently, reserving of a target amount is not achieved inclusive of cancellation before term.

Reserving with automatic deduction of a certain amount of money is performed, regardless of the dairy effort, action pattern, or the like of the user who attempts to suppress spending. Thus, the reserving has no interest for the user and hardly gives the user an urge for economization, such as a motive or an inducement.

Thus, a technology or service in which the user is consciously roused to voluntary economization or spending suppression to perform reserving actively and furthermore the user performs reserving of a target amount effectively in a flexible and agile aspect that is not simple fixed cumulation or the like, has been considered desirable. However, no effective suggestion has been made until now.

Note that Patent Literature 1 discloses an “automatic reserving system” in which, at repayment of a deposit from an account in a financial institution, part in the amount of repayment is automatically reserved.

The system according to Patent Literature 1 enables improvement of the deposit balance in an account for automatic reserving, based on “the more frequently a deposit is repaid, the more a deposit increases”.

### CITATION LIST

### Patent Literature

### Patent Literature 1: JP 2003-132224 A

### SUMMARY OF INVENTION

### Technical Problem

However, the system disclosed in Patent Literature 1 reserves and moves part of the amount of repayment of a deposit (e.g., 20% of the amount of repayment) into a different account for reserving. Thus, an increase in the amount of reserving results from an increase in the amount of repayment.

Thus, for example, if redundant repayment is made in anticipation of an amount of money to be allocated to reserving (20% of the amount of repayment), no increase is made in the total amount of reserving of the user. Thus, it is difficult to say that the system has an effective reserving method.

Only allocation of part of the amount of repayment to reserving is not sufficient for an urge for suppression and economization of spending. For example, the reserving has no purpose and no interest. In other words, because of “the more frequently a deposit is repaid, the more a deposit increases”, there is a concern that needless and unnecessary repayment is made.

Thus, the system according to Patent Literature 1 is not sufficient for achievement of continuous reserving along the daily spending, action pattern, or the like of the user as described above.

The present invention has been proposed in order to solve the problem in the conventional technology as above. An object of the present invention is to provide a fractional fund transfer and accumulation system enabling achievement of effortlessly efficient and continuous reserving by computation of a predetermined fractional amount based on user's daily payment or the like, and transfer of the fractional amount as a reserving amount to a target amount, the fractional fund transfer and accumulation system enabling natural encouragement and evocation of active reserving action with an urge for suppression, economization, or the like of spending, the fractional fund transfer and accumulation system being suitable for reserving or the like of a purchase fund for a desired product or service.

### Solution to Problem

In order to achieve the above object, according to the present invention, there is provided a fractional fund transfer and accumulation system which transfers, based on rule information set in accordance with an input operation of a customer, a fund from a fund account of the customer to a predetermined accumulation account to accumulate a predetermined target amount, the fractional fund transfer and accumulation system including: target amount storage means for storing predetermined target amount information set in accordance with an input operation; fund calculation rule storage means for storing predetermined fund calculation rule information set in accordance with an input operation; account information storage means for storing account information regarding the fund account of the customer; fund calculation means for calculating, based on the fund calculation rule information, a transfer amount of a transfer fund to be transferred from the fund account of the customer to the predetermined accumulation account; fund transfer instruction means for transmitting, based on the calculated transfer amount, predetermined fund transfer instruction information to a predetermined financial institution device that manages the fund account of the customer; accumulated fund information generation means for generating predetermined accumulated fund information including the transfer amount; accumulated fund storage means for storing the accumulated fund information; and target amount achievement computation means for computing, based on the accumulated fund information and the target amount information, a predetermined degree of achievement of an accumulated fund to the target amount.

Note that, according to the present invention, there can be provided a fractional fund transfer and accumulation program to be executed in the fractional fund transfer and accumulation system according to the present invention as described above.

Furthermore, according to the present invention, there can be provided a fractional fund transfer and accumulation method executable by the fractional fund transfer and accumulation system and the fractional fund transfer and accumulation program according to the present invention as described above.

### Advantageous Effects of Invention

According to the present invention, a predetermined fractional amount can be computed on the basis of user's daily payment or the like, and the fractional amount can be transferred as a reserving amount to a target amount.

This arrangement enables achievement of effortlessly efficient and continuous reserving, and enables natural encouragement and evocation of active reserving action with an urge for suppression, economization, or the like of spending.

Therefore, service flexibly responding to various needs, action patterns, or the like of various users, the service being particularly suitable for reserving a purchase fund for a product or service for an individual, a family, or a group can be provided.

### BRIEF DESCRIPTION OF DRAWINGS

FIG. 1 is a block diagram of the configuration of a fractional fund transfer and accumulation system according to an embodiment of the present embodiment.

FIG. 2 is a block diagram of the configuration of storage means (fractional fund transfer and accumulation DWH) included in the fractional fund transfer and accumulation system illustrated in FIG. 1.

FIG. 3 is an explanatory illustration of exemplary “fund calculation rules” settable in the fractional fund transfer and accumulation system according to the embodiment of the present invention.

FIG. 4 is an explanatory illustration of an exemplary processing operation of fund transfer in the fractional fund transfer and accumulation system according to the embodiment of the present invention.

FIG. 5 is an explanatory illustration of an exemplary processing operation of fund transfer in the fractional fund transfer and accumulation system according to the embodiment of the present invention, following FIG. 4.

FIG. 6 is an explanatory illustration of exemplary display screens output and displayed on the customer terminal side in the fractional fund transfer and accumulation system according to the embodiment of the present invention. FIG. 6(a) illustrates accumulated fund information at the point in time corresponding to FIG. 4, and FIG. 6(b) illustrates accumulated fund information at the point in time corresponding to FIG. 5.

FIG. 7 is an explanatory illustration of exemplary display screens output and displayed on the customer terminal side in the fractional fund transfer and accumulation system according to the embodiment of the present invention. FIG. 7(a) illustrates a setting screen selectably displaying various setting items settable in the fractional fund transfer and accumulation system, FIG. 7(b) illustrates a setting screen for “fund calculation rules” selected in FIG. 7(a), and FIG. 7(c) illustrates a setting screen for “monthly closing date” selected in FIG. 7(a).

FIG. 8 is an explanatory illustration of exemplary display screens output and displayed on the customer terminal side in the fractional fund transfer and accumulation system according to the embodiment of the present invention. FIG. 8(a) illustrates a setting screen selectably displaying each setting item in “fund calculation rules” corresponding to FIG. 3, and FIG. 8(b) illustrates a setting screen for “change balance rules” selectable in FIG. 8(a).

FIG. 9 is an explanatory illustration of exemplary display screens output and displayed on the customer terminal side in the fractional fund transfer and accumulation system according to the embodiment of the present invention. FIG. 9(a) illustrates a setting screen for “alert notification” selected in FIG. 7(a), FIG. 9(b) illustrates a setting screen for “monthly target saving amount” and a setting screen for “economization rules” for alert notification selected in FIG. 9(a), and FIG. 9(c) illustrates a setting screen for the “monthly target saving amount” selected in FIG. 7(a).

FIG. 10 is an explanatory illustration of exemplary display screens output and displayed on the customer terminal side in the fractional fund transfer and accumulation system according to the embodiment of the present invention. FIG. 10(a) illustrates a setting screen for the “accounts for fund saving” selected in FIG. 7(a), FIG. 10(b) illustrates a setting screen for “create a new account for fund saving” selected in FIG. 10(a), and FIG. 10(c) illustrates a setting screen for an account for “fund raising” selected and set in FIG. 10(b).

FIG. 11 is an explanatory illustration of an exemplary processing operation of fund transfer in the fractional fund transfer and accumulation system according to the embodiment of the present invention, and illustrates an account for “fund raising” set in addition to an account for “standard” in the fund status corresponding to FIG. 4.

FIG. 12 is an explanatory illustration of exemplary display screens output and displayed on the customer terminal side in the fractional fund transfer and accumulation system according to the embodiment of the present invention. FIG. 12(a) illustrates accumulated fund information regarding the account for “standard” at the point in time corresponding to FIG. 11, and FIG. 12(b) illustrates accumulated fund information regarding the account for “fund raising”, similarly.

FIG. 13 is an explanatory illustration of an exemplary processing operation of fund transfer in the fractional fund transfer and accumulation system according to the embodiment of the present invention, following FIG. 11, and illustrates fund transfer performed to the account for “fund raising” in the fund status corresponding to FIG. 5.

FIG. 14 is an explanatory illustration of exemplary display screens output and displayed on the customer terminal side in the fractional fund transfer and accumulation system according to the embodiment of the present invention. FIG. 14(a) illustrates accumulated fund information regarding the account for “standard” at the point in time corresponding to FIG. 13, and FIG. 14(b) illustrates accumulated fund information regarding the account for “fund raising”, similarly.

FIG. 15 is an explanatory illustration of exemplary display screens output and displayed on the customer terminal side in the fractional fund transfer and accumulation system according to the embodiment of the present invention. FIG. 15(a) illustrates a setting screen for “create a new account for fund saving” similar to that in FIG. 10(b), FIG. 15(b) illustrates a setting screen for an account for “fund raising” selected and set in FIG. 15(a), and FIG. 15(c) illustrates a detailed setting screen for “sharing” selected in FIG. 15(b).

FIG. 16 is an explanatory illustration of point granting corresponding to the degree of achievement of a target amount in the fractional fund transfer and accumulation system according to the embodiment of the present invention. FIG. 16(a) illustrates the concept of a continuation point for a predetermined period, and FIG. 16(b) is a table of specific examples of the continuation point corresponding to a final target amount and a monthly target saving amount.

FIG. 17 is an explanatory illustration of exemplary display screens output and displayed on the customer terminal side in the fractional fund transfer and accumulation system according to the embodiment of the present invention. FIG. 17(a) illustrates a display screen displaying the degree of achievement of an accumulated fund to a set target amount, and FIG. 17(b) illustrates a display screen notifying that points corresponding to the degree of achievement illustrated in FIG. 17(a) have been granted.

FIG. 18 is an explanatory illustration of exemplary display screens output and displayed on the customer terminal side in the fractional fund transfer and accumulation system according to the embodiment of the present invention. FIG. 18(a) illustrates a display screen displaying the degree of achievement of an accumulated fund to a set target amount, FIG. 18(b) illustrates a display screen in a case where a product displayed on a display screen for “offer” selected in FIG. 18(a) is registered onto a “wish list”, and FIG. 18(c) illustrates a display screen in a case where an “automatic order” function is set at valid/invalid (ON/OFF) for the product registered on the “wish list” in FIG. 18 (b).

FIG. 19 is an explanatory illustration of exemplary display screens output and displayed on the customer terminal side in the fractional fund transfer and accumulation system according to the embodiment of the present invention. FIG. 19(a) illustrates a display screen displaying the degree of achievement of an accumulated fund to a set target amount, FIG. 19(b) illustrates a display screen notifying that order processing of the product set with the “automatic order” function has been performed in accordance with the degree of achievement illustrated in FIG. 19(a), and FIG. 19(c) illustrates a display screen inquiring about order processing of a product not set with the “automatic order” function, similarly.

FIG. 20 is an explanatory illustration of exemplary display screens output and displayed on the customer terminal side in the fractional fund transfer and accumulation system according to the embodiment of the present invention. FIG. 20(a) illustrates a display screen in a case where the degree of achievement of an accumulated fund to a target amount is “0%”, FIG. 20(b) illustrates a display screen for “31%”, similarly, and FIGS. 20(c) and 20(d) illustrate display screens presenting merchandise available for purchase with a predicted amount possible to attain on a set “target achievement date”, in accordance with the degrees of achievement illustrated in FIGS. 20(a) and 20(b).

FIG. 21 is an explanatory illustration of exemplary display screens output and displayed on the customer terminal side in the fractional fund transfer and accumulation system according to the embodiment of the present invention. FIG. 21(a) illustrates a display screen displaying the degree of achievement of an accumulated fund to a set target amount, FIG. 21(b) illustrates a display screen indicating an exemplary operation of saving “sponsor point” on a display screen for “offer” selected in FIG. 21(a), and FIG. 21(c) illustrates a flowchart of processing operation in a case where the “sponsor point” is granted in accordance with the operation performed in FIG. 21(b), and a display screen for verification of the granted “sponsor point”.

FIG. 22 is an explanatory illustration of exemplary display screens output and displayed on the customer terminal side in the fractional fund transfer and accumulation system according to the embodiment of the present invention. FIG. 22(a) illustrates a display screen displaying the degree of achievement of an accumulated fund to a set target amount and a display screen displaying the “sponsor point” having been saved at the point in time, FIG. 22(b) illustrates a display screen inquiring about order processing of a desired service (travel), and FIG. 22(c) illustrates a display screen inquiring whether the appropriate “sponsor point” is to be allocated to payment for the order processing indicated in FIG. 22(b).

FIG. 23 is an explanatory illustration of exemplary display screens output and displayed on the customer terminal side in the fractional fund transfer and accumulation system according to the embodiment of the present invention. FIG. 23(a) illustrates “account balance fractional rules” added as a setting item on a setting screen for “fund calculation rules” corresponding to FIGS. 3 and 8, and FIG. 23(b) illustrates a setting screen for the “account balance fractional rules” selectable in FIG. 23(a).

FIG. 24 is a diagram of the hardware configuration of a server or a terminal in the fractional fund transfer and accumulation system according to the embodiment of the present invention.

### DESCRIPTION OF EMBODIMENTS

An embodiment of a fractional fund transfer and accumulation system according to the present invention will be described below with reference to the drawings.

Here, the fractional fund transfer and accumulation system according to the present invention below is achieved by processing, means, and functions that a computer performs in response to an order from a program (software). The program sends a command to each constituent element of the computer, so that predetermined processing, functions, or the like according to the present invention can be performed. That is each piece of processing, each means, or each function according to the present invention is achieved by specific means in which the program and the computer cooperate.

Note that the entirety or part of the program is provided by, for example, a magnetic disk, an optical disc, a semiconductor memory, or any computer-readable recording medium. The program read from the recording medium is installed on the computer so that the program is executed. The program can be directly loaded on the computer through a communication line with no recording medium so that the program can be executed. The fractional fund transfer and accumulation system according to the present invention can include a single information processing device (e.g., one personal computer) or can include a plurality of information processing devices (e.g., a group of a plurality of server computers).

### [System Configuration]

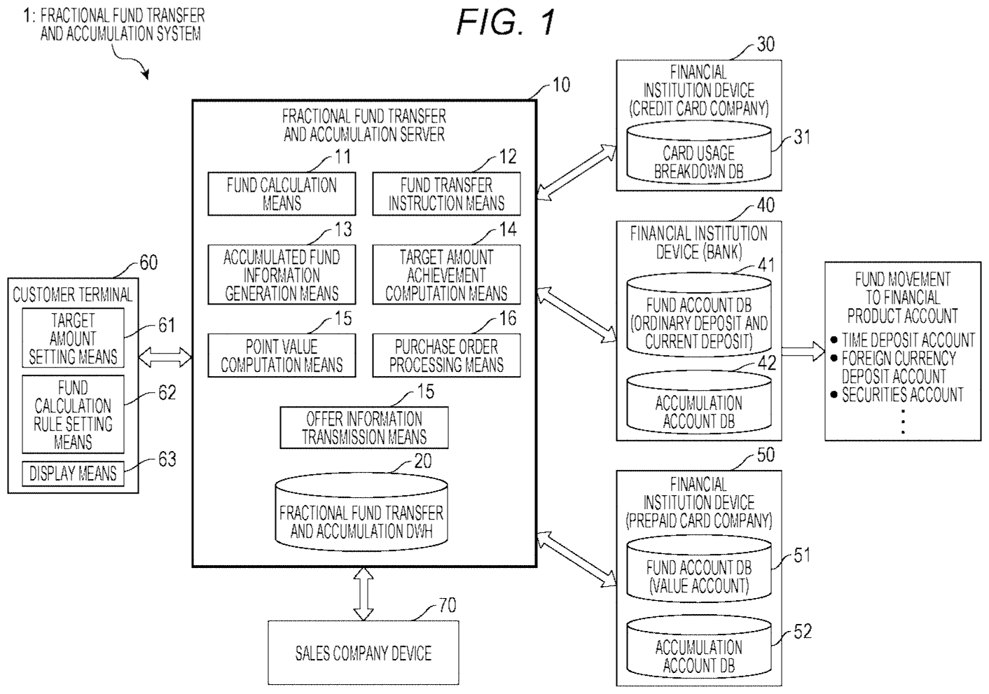

FIG. 1 illustrates the configuration of a fractional fund transfer and accumulation system according to the embodiment of the present invention.

The system according to the embodiment of the present invention illustrated in the figure is provided as a fractional fund transfer and accumulation system 1 including a fractional fund transfer and accumulation server 10, financial institution devices 30 to 50, a customer terminal 60, and a sales company device 70.

The fractional fund transfer and accumulation server 10, the financial institution devices 30 to 50, the customer terminal 60, and the sales company device 70 included in the fractional fund transfer and accumulation system 1, are connected through a predetermined network, such as the Internet, such that mutual data communication is allowable.

### [Fractional Fund Transfer and Accumulation Server 10]

The fractional fund transfer and accumulation server 10 is an information processing device that transfers, on the basis of rule information set in accordance with an input operation of a customer (user), a fund from a fund account of the customer to a predetermined accumulation account to accumulate a predetermined target amount. The fractional fund transfer and accumulation server 10 is part of the fractional fund transfer and accumulation system according to the present invention.

Specifically, for example, the fractional fund transfer and accumulation server 10 can include one or not less than two server computers or can include a server system including one or not less than two virtual servers built on a cloud computing service.

The fractional fund transfer and accumulation server 10 including an operating system (OS) and a database management system (DBMS) not illustrated, serves as a server computer.

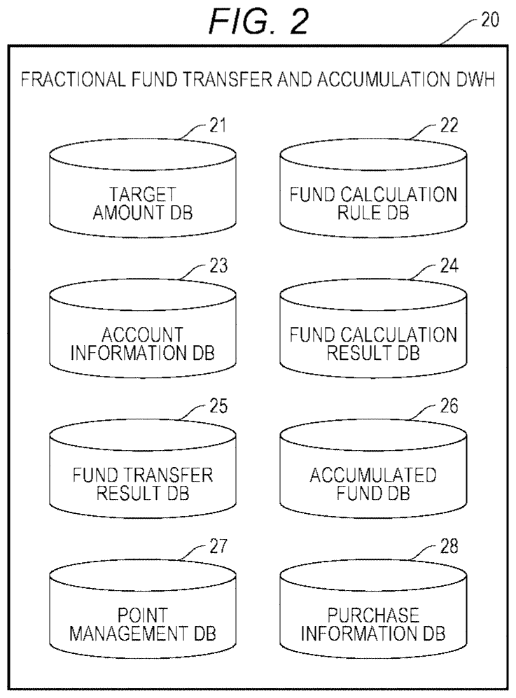

Note that the constituent elements of the fractional fund transfer and accumulation server 10 illustrated in FIG. 1 can be appropriately provided to the customer terminal 60. For example, a fund calculation rule DB 22 (refer to FIG. 2), fund calculation means 11, and a fund calculation result DB 24 can be implemented on the customer terminal 60.

Software that operates on middle ware, such as a Web server program is implemented on the fractional fund transfer and accumulation server 10.

For the software, an application available pursuant to, for example, an application programming interface (API) is released and provided to one or not less than two customer terminals 60 through the network, such as the Internet.

With this arrangement, each customer terminal 60 calls, for example, a dedicated application program or Web browser managed for provision of a service, such as a suggestion for or a piece of advice on asset management provided to a customer in a financial institution or the like (hereinafter, referred to as a “user”), so that the function of the fractional fund transfer and accumulation system according to the present invention can be performed.

The fractional fund transfer and accumulation server 10 including a fractional fund transfer and accumulation data warehouse (DWH) 20 implemented as a database or the like (refer to FIG. 2), includes the respective databases of a target amount DB 21, the fund calculation rule DB 22, an account information DB 23, the fund calculation result DB 24, a fund transfer result DB 25, an accumulated fund DB 26, a point management DB 27, and a purchase information DB 28, to be described later, and further includes storage means that acquires and accumulates predetermined information necessary for management of the fractional fund transfer and accumulation system according to the present invention.

The storage means stores, as various information resources, for example, account information, attribute information, and transaction history information regarding a user in a financial institution, to be described later, and further stores predetermined information necessary for the fractional fund transfer and accumulation server 10 according to the present embodiment. Along with management of the fractional fund transfer and accumulation server 10, necessary information is read at any time, and then storage and updating are performed.

Note that information to be stored and accumulated in the fractional fund transfer and accumulation server 10 in this manner is periodically extracted with daily processing or the like from its own financial institution system as an accounting-and-informational information processing system in each of the financial institutions having the financial institution devices 30 to 50 or from an financial-institution backbone system that provides a plurality of financial institutions with an accounting-and-informational information processing system, so that the information can be acquired and accumulated in the fractional fund transfer and accumulation server 10. In a case where each financial institution does not have its own information processing system, external backbone system, or the like enabling cooperation, for example, various types of information can be manually registered and accumulated in the fractional fund transfer and accumulation server 10.

Furthermore, use of a different program (e.g., an application in the customer terminal 60) enables acquisition and reference of the information accumulated in the fractional fund transfer and accumulation server 10 through the network. For example, in a case where the information accumulated in the fractional fund transfer and accumulation server 10 can be acquired and referred to with respective programs of the financial institution devices 30 to 50 through the network, each financial institution (e.g., a credit card company, a bank, or a prepaid card company) analyzes, from, for example, rules and a target amount set by a user and transaction history information, the life style or taste of the user, so that the information can be used for marketing.

Specifically, as illustrated in FIG. 1, the fractional fund transfer and accumulation server 10 above functions as the fund calculation means 11, fund transfer instruction means 12, accumulated fund information generation means 13, target amount achievement computation means 14, point value computation means 15, purchase order processing means 16, and offer information transmission means 17.

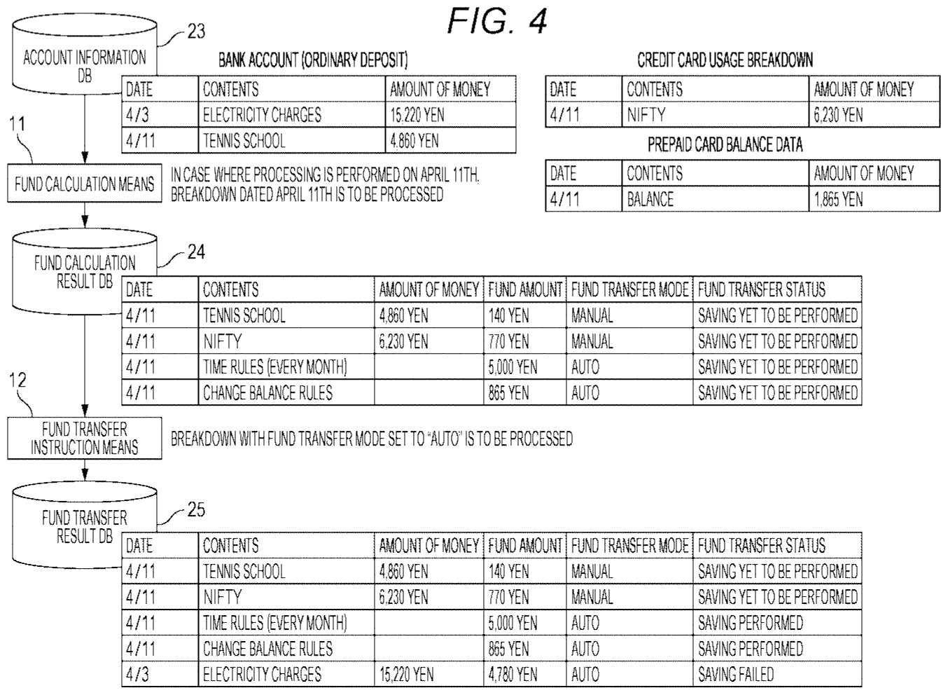

On the basis of fund calculation rule information set and stored in the fund calculation rule DB 22 and account information stored in the account information DB 23 in the fractional fund transfer and accumulation DWH 20, the fund calculation means 11 calculates a transfer fund to be transferred from the fund account of the appropriate user to the predetermined accumulation account (refer to FIGS. 4, 5, 11, and 13 to be described later).

Specifically, the fund calculation means 11 computes, as the “transfer amount” according to the present invention, a fractional amount indicated by the difference between a deduction amount from the ordinary deposit account or current deposit account in the bank as the fund account of the user and a predetermined set amount.

The fund calculation means 11 computes, as the “transfer amount” according to the present invention, a fractional amount indicated by the difference between a deposit amount (value) in the value account of the prepaid card as the fund account of the user and a predetermined set amount. This arrangement enables accumulation of a fractional amount less than the predetermined set amount in the balance amount of the prepaid card that the user uses for daily shopping, fares, or the like, as the “transfer amount” for fractional saving.

For example, for automatic saving of a fraction cumulated for one day with the prepaid card, a fraction less than 1000 yen in the balance of the prepaid card used for one day is saved as the “transfer amount”, so that the amount of money equivalent to the remaining fraction after payment in cash with a purse can be saved.

Together with or instead of such a fractional amount, the fund calculation means 11 can compute a predetermined fixed amount as the “transfer amount” according to the present invention.

In a case where predetermined event information is input, the fund calculation means 11 can compute the fixed amount as the “transfer amount”.

The fund calculation means 11 can compute that the deduction amount in the fund account of the user described above has attained a predetermined value, and can cause the accumulated fund information generation means 13 to be described later to transmit information indicating that the deduction amount has retained the predetermined value, for example, an alert notification to the customer terminal 60.

Furthermore, in a case where the target amount for a predetermined period (e.g., one month or two years) has been set, the fund calculation means 11 can compute the possibility that the total of the transfer amount in the predetermined period does not attain the target amount. The fund calculation means 11 can cause the accumulated fund information generation means 13 to transmit information indicating the possibility that the total of such a transfer amount does not attain the target amount (e.g., alert notification) to the customer terminal 60. The possibility that the transfer amount does not attain the target amount can be estimated in comparison to the past records (e.g., the previous month).

Such announcement of the alert notification or the like enables, in a case where, for example, economization rules to be described later are likely to be broken due to an increase in the deduction amount or the target amount is likely to be difficult to achieve, the user to be notified of the possibility. Thus, the user can be urged to stop wasting money for economization.

On the basis of fund calculation result information stored in the fund calculation result DB 24 of the fractional fund transfer and accumulation DWH 20, the fund transfer instruction means 12 transmits predetermined fund transfer instruction information to the financial institution devices 40 and 50.

The accumulated fund information generation means 13 generates predetermined accumulated fund information including a fund transfer result, and transmits the accumulated fund information to the customer terminal 60 operable by the user such that the user can refer to the accumulated fund information.

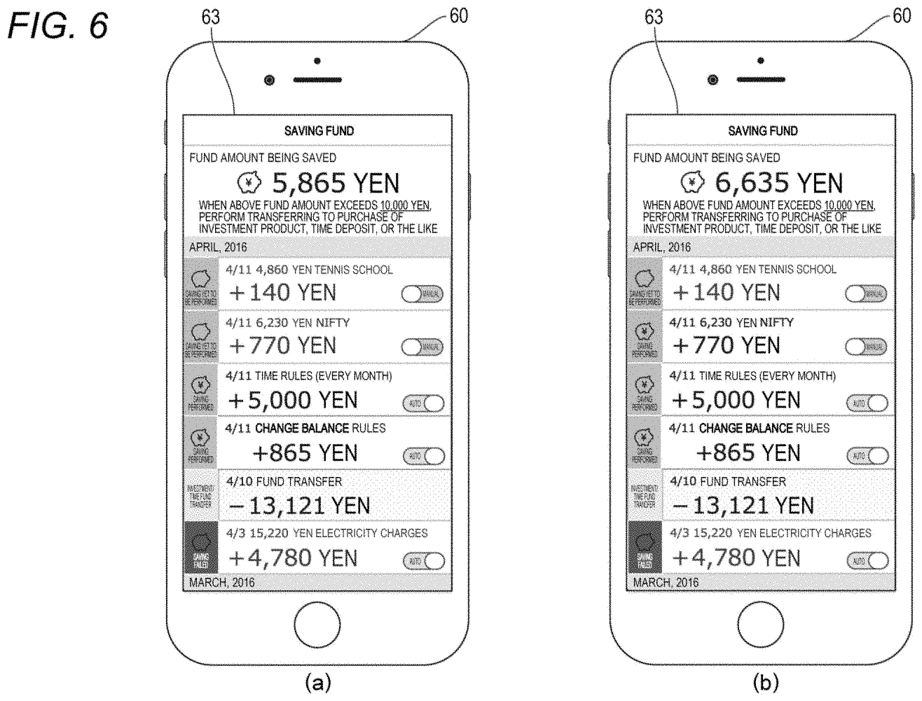

The accumulated fund information to be generated and output by the accumulated fund information generation means 13 is predetermined information indicating the amount of money of the current accumulated fund in the accumulation account in the financial institution device 40 or 50 in which the transfer processing as described above is performed, points, or the like (refer to FIGS. 6, 12, and 14 to be described later). The information is stored in the accumulated fund DB 26.

On the basis of the accumulated fund information stored in the accumulated fund DB 26 and target amount information set and stored in the target amount DB 21 in the fractional fund transfer and accumulation DWH 20, the target amount achievement computation means 14 computes the predetermined degree of achievement of the accumulated fund to the target amount.

The point value computation means 15 computes a predetermined point value to be granted to the user.

As the point value to be computed by the point value computation means 15, the predetermined point value can be computed and granted in accordance with the daily consumption, settlement, or action pattern of the user, such as the amount of money of the accumulated fund indicated as the accumulated fund information described above, the usage breakdown amount or the number of times of usage of the credit card, or the payment amount or the number of times of usage of the prepaid card.

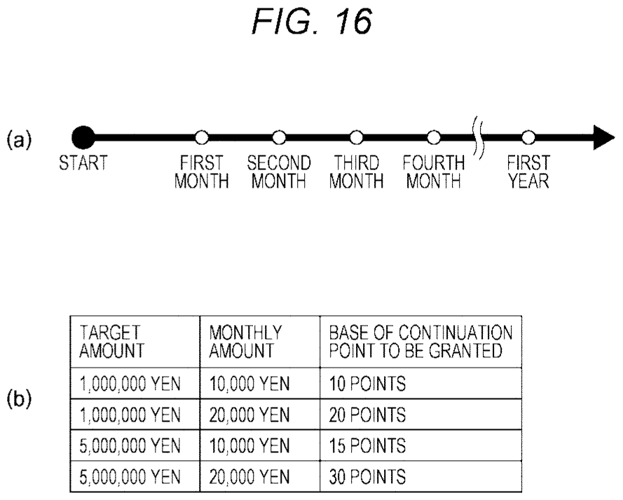

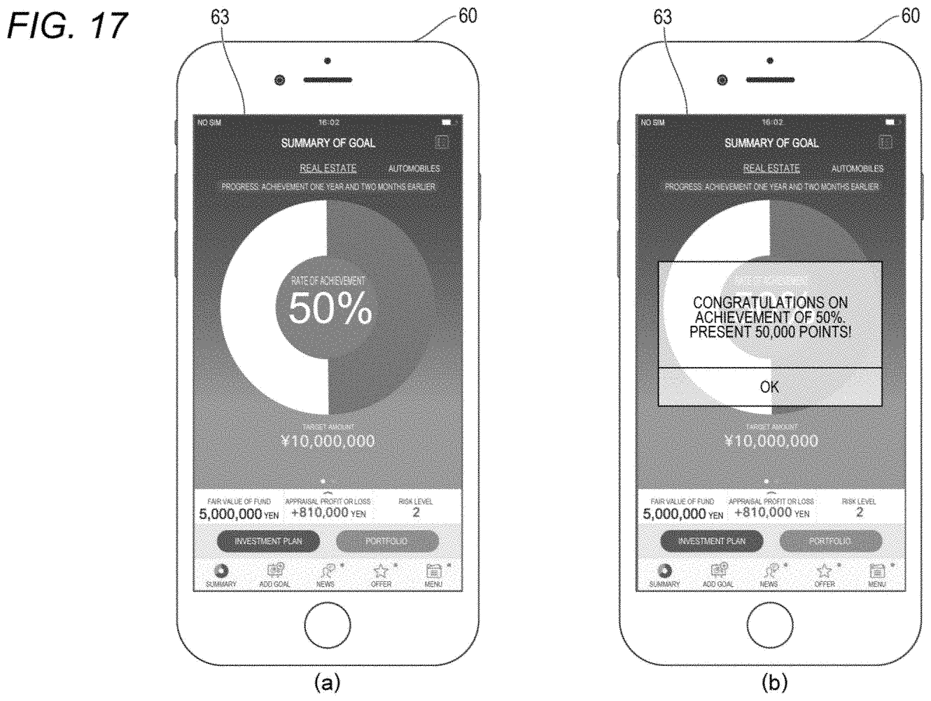

According to the present embodiment, on the basis of the degree of achievement computed by the target amount achievement computation means 14 described above, the point value computation means 15 computes the predetermined point value (refer to FIGS. 16 and 17).

Specifically, the point value computation means 15 computes the predetermined point value corresponding to the degree of achievement, for example, corresponding to a degree of achievement of 10%, 20%, 30%, 40%, 50%, . . . , or 100% computed by the target amount achievement computation means 14, and then grants and adds the predetermined point value to the appropriate user.

In a case where the sales company device 70 to be described later provides a predetermined sponsor point, the point value computation means 15 computes the sponsor point as the point value, and then grants and adds the sponsor point as the point value to the appropriate user.

Here, the point to be granted to the user can be made into a point value allocable to purchase of predetermined products or services as cash together with the accumulated fund accumulated in the present system and only available in a specific trading area (e.g., shops, services, and WEB sites).

Granting of such a point enables the user to be given an incentive for fractional saving with the present system or achievement of the target amount, and enables the user to be urged to purchase of products or services in the specific trading area in which the point is available or to consumption activity.

The point is granted little by little at each stage (milestone) corresponding to the degree of achievement until the target amount is attained, so that, for example, the user can be prevented from changing the target amount or target product easily before the attainment. If the target product or the like is changed, the point available to the product disappears, so that the promotion of target achievement can be made.

In this manner, according to the present embodiment, granting and adding of the predetermined point value corresponding to the degree of achievement of the target amount or the like, enables enhancement of merit, convenience, and incentive and continuity to reserving for the user to the present system, in comparison to a coupon ticket exchangeable for specific products.

The point value granted to the user is stored and managed in the point management DB 27 of the fractional fund transfer and accumulation DWH 20.

On the basis of predetermined purchase information regarding purchase that the user desires on the basis of the accumulated fund in the present system, the purchase order processing means 16 performs predetermined purchase order processing in a case where the degree of achievement of the accumulated fund to the target amount attains a predetermined value.

The purchase information regarding a product, a service, or the like that the user desires to purchase is set and stored in the purchase information DB 28 of the fractional fund transfer and accumulation DWH 20.

Here, for the purchase information regarding the purchase that the user desires, in accordance with an input operation on the customer terminal 60, for example, WEB information including text and an image indicating, for example, the content and price of the product or service being desired and considered for purchase and information regarding URL or the like specifying the WEB information can be registered in the purchase information DB 28 similarly to a so-called “wish list” or “want list”, in cooperation with WEB information regarding products or services provided on an Internet-shopping site or the like.

When the accumulated fund of each user attains the set target amount, the purchase order processing means 16 automatically performs order processing (purchase processing) to a WEB site, such as a cooperative shopping site, for the product or service registered as the purchase information. Therefore, each user registers any purchase information in the present system (application) from the user's customer terminal 60, so that each user can automatically purchase the appropriate product or the like after target achievement of the accumulated fund.

After the accumulated fund attains the target, the purchase order processing means 16 can transmit and report predetermined notification information to the appropriate user to perform order-placement and order processing.

After the accumulated fund attains the target, the purchase order processing means 16 performs automatic order processing without verification of order placement, resulting in dispatch of the purchase to the appropriate user. Thus, for example, surprise amazement or pleasure can be given to the user.

Note that, in some cases, the price of the product or the like registered on the “wish list” or the like varies on an Internet-shopping site or the like after the registration.

In this case, the present system fixes, at the point in time the target amount and the purchase information regarding the product or the like are set, the amount of money of the appropriate product. Thus, even in a case where the selling price at the point in time is higher than the target amount of the accumulated fund, the product can be purchased at the amount of money at the point in time of the target set.

In a case where the amount of money of the appropriate product or the like is lower than the amount of money at the point in time of the target set, the product can be purchased at the low amount of money.

The automatic order processing in the purchase order processing means 16 can be set so as to be performed at the specific date and time, in accordance with an input operation from the customer terminal 60 of the user.

With this arrangement, for example, in a case where the birthday or an anniversary of the family or a friend is set as a target day and the target amount is saved before the target day, the purchase order processing means 16 can perform the automatic order processing for the specific day.

Specifically, in a case where a user decides the target amount and the target day and then purchases earrings for his wife through the present system, the birthday of his wife, the earrings, and a predetermined amount of money with which the earrings can be purchased can be set as the target day, the purchase information, and the target amount, respectively. In accordance with the status of the accumulated fund of the user, the purchase order processing means 16 collects and extracts information regarding a candidate product (earrings) available for purchase to present the information to the customer terminal 60. In accordance with, for example, a purchase operation of the user, the purchase order processing means 16 performs order-placement processing by approximately one week before, so that the product can be delivered on the designated day.

The offer information transmission means 17 receives predetermined offer information including a point value grantable to the user, from the sales company device 70 installed in a sales company that provides a predetermined purchase, and then transmits the offer information browsably to the customer terminal 60 operable by the user.

Here, the offer information is transmitted and provided from the sales company device 70 to the customer terminal 60 of the user through the present system, for the sale or advertising campaign of products or services. The offer information includes WEB information including text and images indicating, for example, the contents and prices of products or services that each sales company provides, and URL.

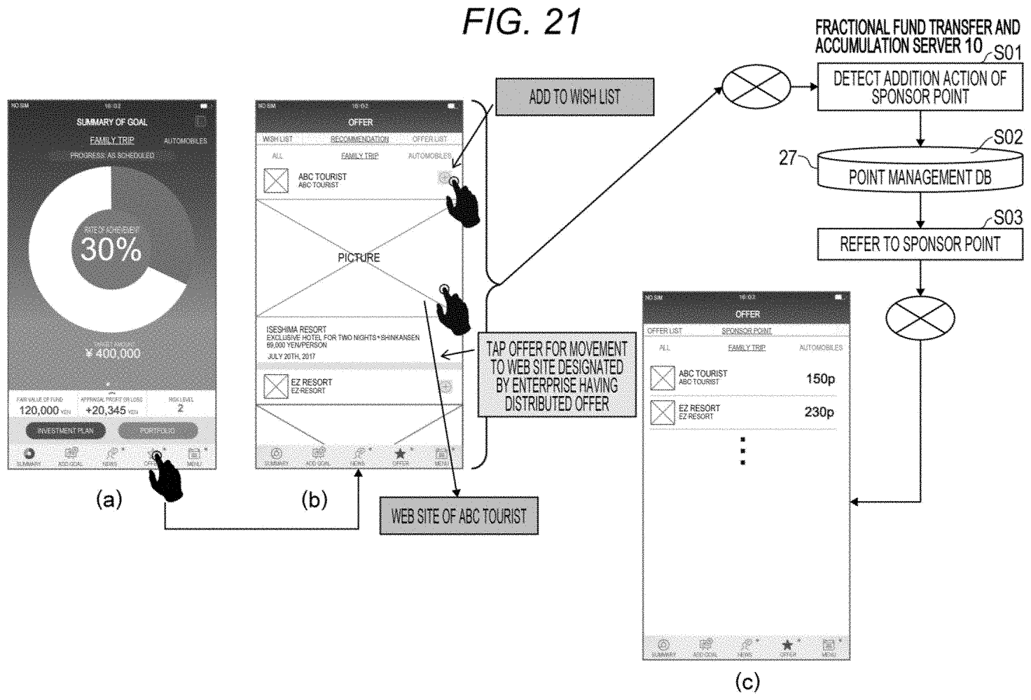

The offer information includes an offer of the point (sponsor point) to be provided to the users in the present system from each sales company or maker. For example, a predetermined point is granted to the user who has browsed the appropriate offer information (refer to FIG. 21).

With this arrangement, the user browses only interesting offer information from the operating customer terminal 60 through the present system, so that the user can receive the point being provided and granted thereat.

Specifically, the point value included in offer information selected by the customer terminal 60 in accordance with an input operation is stored and managed in the point management DB 27 as the predetermined point value according to the present system.

Note that although the point included in the offer information can be managed by being added to the point value computed and granted by the point value computation means 15 described above, for example, the point can be stored and managed independently every company as the point (sponsor point) of each company that provides the point.

For example, the user sets the target amount for “travel to Hawaii Island”. In a case where the offer information including point granting is provided from a plurality of travel agencies, the user browses the offer information from each travel agency, so that the user can obtain the point from each company. In a case where the target amount is achieved, the user makes a purchase and application for a travel tour in the travel agency largest in point value, so that the user can allocate the granted point to the travel price.

The sponsor point to be granted independently every company can be granted by posting an assessment, a questionnaire, an SNS posting, or the like for the company through the Internet, in addition to by browsing. For example, like the case of granting of the point only by an SNS posting or granting of the point after another person browses posting information, the point can be saved effortlessly. In this case, each user is provided with information such that the accumulated point status according to a company is grasped (refer to FIG. 21).

Such granting of the sponsor point is effective for each sales company or maker that desires personal information regarding each user, for example. Provision of point granting on condition of user registration or the like enables collection of valuable information, such as the personal information or interest and taste of each user.

### [Fractional Fund Transfer and Accumulation DWH 20]

As illustrated in FIG. 2, the fractional fund transfer and accumulation DWH 20 serving as storage means includes the target amount DB 21, the fund calculation rule DB 22, the account information DB 23, the fund calculation result DB 24, the fund transfer result DB 25, the accumulated fund DB 26, the point management DB 27, and the purchase information DB 28.

The target amount DB 21 serves as storage means that stores predetermined target amount information every user set in accordance with an input operation from the customer terminal 60 of the user.

The target amount information to be set and stored in the target amount DB 21 includes information regarding, for example, the target amount that the user finally saves in the present system, the target period for saving of the target amount, and the monthly target saving amount.

With the target amount information set in the target amount DB 21 as the “goal (target)”, the present system functions as a “goal-based platform (GBP)” server that provides various services for urging the user to saving or investment action toward achievement of the target (goal).

The fund calculation rule DB 22 serves as storage means that stores predetermined fund calculation rule information every user set in accordance with an input operation from the customer terminal 60 of the user.

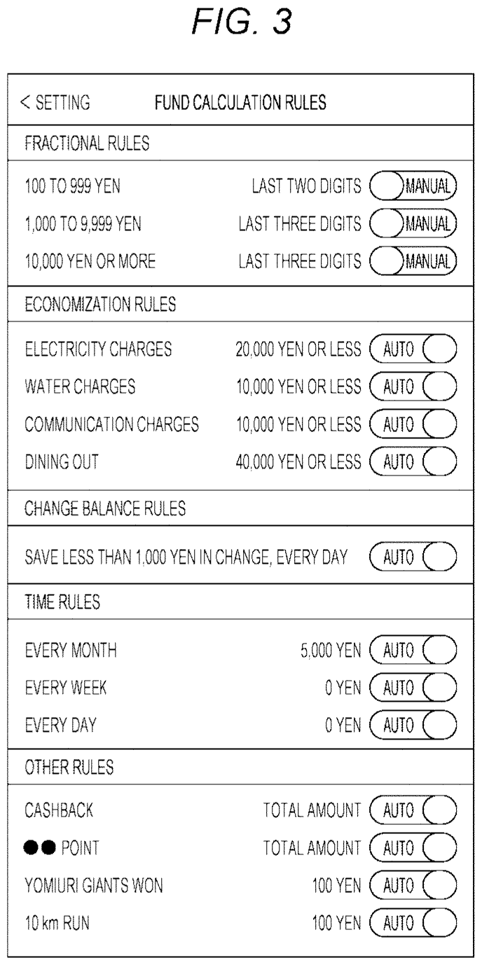

Here, the fund calculation rule information to be stored in the fund calculation rule DB 22 includes, as described later, various rules for achievement of the target amount set in the target amount DB 21 described above (e.g., fractional rules, economization rules, change balance rules, time rules, and other rules) as predetermined information that the user sets through the customer terminal 60 (refer to FIG. 3 to be described later).

The account information DB 23 serves as storage means that receives and stores account information regarding, for example, the fund account of the user, from the financial institution devices 30 to 50 that manage, for example, the fund account of the user.

Here, the account information to be stored in the account information DB 23 includes usage breakdown information regarding the credit card transmitted from the financial institution device 30 at the credit card company, transaction information regarding the fund account transmitted from the financial institution device 40 at the bank, and balance information (value information) regarding the deposit amount of the prepaid card transmitted from the financial institution device 50 at the prepaid card company, to be described later (refer to FIGS. 4, 5, 11, and 13 to be described later).

The fund calculation result DB 24 serves as storage means that stores information indicating a fund calculation result including the transfer fund computed by the fund calculation means 11.

The fund calculation result information to be stored in the fund calculation result DB 24 is predetermined information necessary for performance of the transfer processing from the fund account to the accumulation account, to be described later, inclusive of the “transfer amount” calculated and computed by the fund calculation means 11 described above (refer to FIGS. 4, 5, 11, and 13 to be described later).

The fund transfer result DB 25 serves as storage means that receives and stores, from the financial institution device 40 or 50 having transmitted the fund transfer instruction information, information indicating a fund transfer result based on the fund transfer instruction information.

The fund transfer result information to be stored in the fund transfer result DB 25 is predetermined information indicating the result of the transfer processing from the fund account to the accumulation account performed by the bank financial institution device 40 or the prepaid-card financial institution device 50 by the instruction from the fund transfer instruction means 12 as described above (refer to FIGS. 4, 5, 11, and 13 to be described later).

The accumulated fund DB 26 serves as storage means that stores the predetermined accumulated fund information including the fund transfer result, generated by the accumulated fund information generation means 13 described above.

The accumulated fund information to be stored in the accumulated fund DB 26 is predetermined information indicating the amount of money of the current accumulated fund in the accumulation account of the financial institution device 40 or 50 in which the transfer processing as described above is performed, points, or the like (refer to FIGS. 6, 12, and 14 to be described later).

The point management DB 27 serves as storage means that stores predetermined point information including the point value computed and granted by the point value computation means 15 described above.

As the point information to be stored in the point management DB 27, for example, the point value computed on the basis of the degree of achievement computed by the target amount achievement computation means 14 described above and the point value (sponsor point) granted by, for example, browsing the offer information provided from the sales company device 70 are stored and managed as information every user.

The purchase information DB 28 serves as storage means that stores the predetermined purchase information regarding purchase that the user desires on the basis of the accumulated fund.

The purchase information to be stored in the purchase information DB 28 includes WEB information including text and an image indicating, for example, the content and price of the product or service being desired and considered for purchase by each user and information regarding URL or the like specifying the WEB information.

The specific function and operation of each means achieved by the fractional fund transfer and accumulation server 10 and the fractional fund transfer and accumulation DWH 20 according to the present embodiment above will be described later with reference to exemplary display screens output and displayed on the customer terminal 60 (refer to FIGS. 3 to 22).

### [Financial Institution Devices 30 to 50]

The financial institution devices 30 to 50 each are, for example, an information processing device installed in a financial institution such as a credit card company, a bank, or a prepaid card company and are connected to the fractional fund transfer and accumulation server 10 described above such that data communication is allowable.

In the example illustrated in FIG. 1, the financial institution device 30 is the information processing device installed in the credit card company, the financial institution device 40 is the information processing device installed in the bank, and the financial institution device 50 is the information processing device installed in the prepaid card company.

Note that, in the example illustrated in FIG. 1, only one of each of the financial institution device 30 of the credit card company, the financial institution device 40 of the bank, and the financial institution device 50 of the prepaid card company is illustrated. Needless to say, a plurality of financial institution devices 30, a plurality of financial institution devices 40, and a plurality of financial institution devices 50 may be provided in the present system.

### [Credit Card Company]

The financial institution device 30 installed in the credit card company includes a card usage breakdown DB 31 serving as storage means that stores the usage breakdown information regarding the credit cards operated by the credit card company.

The information that the card usage breakdown DB 31 stores includes attribute information regarding the user for each credit card managed and operated by the credit card company and usage breakdown information indicating, for example, the usage date and time, the usage amount, and the usage content of the credit card.

The usage breakdown information that the credit card company retains and manages results in the “deduction amount” according to the present invention, for computation of the transfer amount for the target amount that the user accumulates.

Here, examples of the cards operated by the credit card company include an ordinary personal credit card, a corporate credit card, a family credit card, a student credit card, and a debit card. Any card allowing deduction and settlement of usage and payment with the card from a predetermined bank account may be used as the credit card in the present system.

The information stored in the card usage breakdown DB 31 is transmitted to the fractional fund transfer and accumulation server 10 through the network, and then is stored in the account information DB 23 as the account information regarding each user.

### [Bank]

The financial institution device 40 installed in the bank includes a fund account DB 41 serving as storage means that stores information regarding the deposit accounts operated by the bank.

The information that the fund account DB 41 stores includes attribute information regarding the user for each type of deposit account (e.g., an ordinary deposit account or a current deposit account) managed and operated by the bank and transaction information regarding, for example, the balance and the deposit and withdrawal history of the deposit account.

The deposit account is included in the “fund account” according to the present invention that is the transfer source of the transfer fund for the target amount that the user accumulates.

The deduction amount from the deposit account indicated by the transaction information regarding the deposit account results in the “deduction amount” according to the present invention, for computation of the transfer amount for the target amount that the user accumulates.

Here, examples of the deposit accounts managed and operated by the bank include a high-liquidity deposit (saving) account, such as an ordinary deposit, a current deposit, a reserving deposit, or ordinary savings, and a low-liquidity deposit (saving) account, such as a time deposit, a call deposit, or a cumulative deposit.

Accounts available as deduction accounts for cards and public utility charges, specifically, the ordinary deposit and the current deposit result in the “fund account” according to the present invention.

The information stored in the fund account DB 41 is transmitted to the fractional fund transfer and accumulation server through the network, and then is stored as the account information regarding each user in the account information DB 23.

The financial institution device 40 includes an accumulation account DB 42 serving as storage means that stores information regarding the “accumulation account” (fund saving account) according to the present invention, that is the transfer destination of the transfer fund for the target amount that the user accumulates, as a deposit account operated by the bank.

The accumulation account is an account for accumulation and saving of the transfer fund according to the present invention. Thus, a dedicated account not allowing the user to make a deposit and a withdrawal, such as a separate deposit or a pool account for bond purchase in the financial institution, is allocated to the accumulation account. The accumulation account is included in the “accumulation account” according to the present invention that is the transfer destination of the transfer fund for the target amount that the user accumulates.

The information that the accumulation account DB 42 stores includes attribute information regarding each user who uses the account, and for example, the balance and transaction information such as the deposit and withdrawal history of the accumulation account every user.

The transaction information stored in the accumulation account DB 42 results in predetermined information including a result of the transfer fund for the target amount that the user accumulates, and is transmitted to the fractional fund transfer and accumulation server 10.

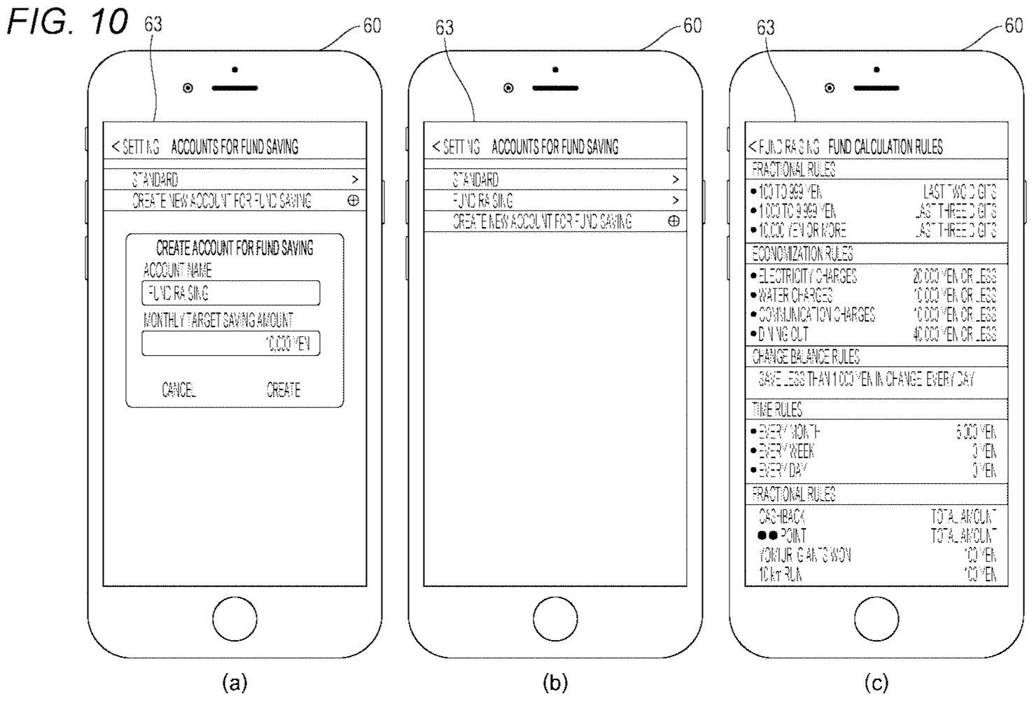

Note that, for such an accumulation account above, as described later, one (single) user can set a plurality of accumulation accounts. This arrangement enables setting of a plurality of accumulation accounts, such as a account for pure fund reserving and an account for fund raising as the accumulation account, corresponding to purposes of reserving, target amounts, or objects to be economized (refer to FIGS. 10 to 14 to be described later), resulting in urging to more positive and active reserving or economization action.

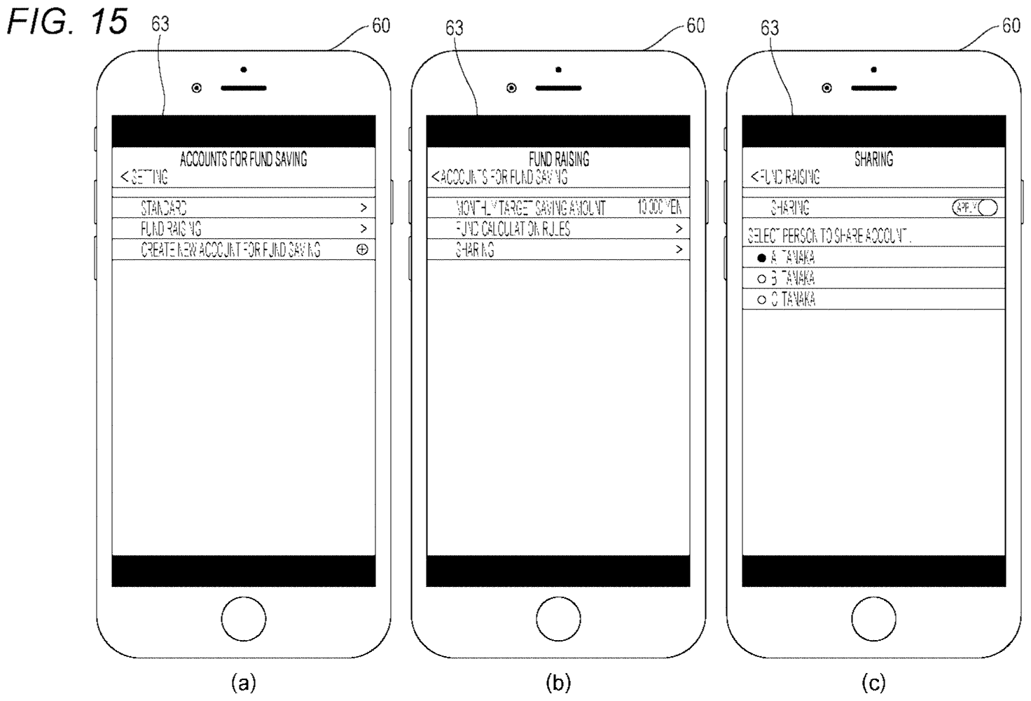

For the accumulation account, one (sharing) accumulation account can be set between a plurality of users. This arrangement enables, for example, a family of three people to reserve a fractional fund or an economization fund into one accumulation account (refer to FIG. 15 to be described later), so that more efficient reserving can be performed.

When the transfer amount in the accumulation account as described above attains a predetermined amount of money, the financial institution device 40 can perform purchase processing of a predetermined financial product (fund movement) with the transfer fund. The purchase processing of the financial product can be performed automatically or after acquisition of the approval and request of the user, in the financial institution device 40.

Here, examples of the financial product available for purchase (fund movement) with the transfer fund in the accumulation account include a time deposit, a foreign currency deposit, an investment trust fund, and securities, such as a stock and a bond.

Note that the purchase of the financial product (fund movement) enables purchase of a financial product on sale from the financial institution (e.g., a time deposit) at the financial institution (bank) equipped with the financial institution device 40. The purchase of the financial product enables purchase of a financial product on sale from a financial institution different from the financial institution equipped with the financial institution device 40, for example, another bank, a securities company, or a foreign bank. In that case, for example, the transfer fund that is a purchase fund is remitted or transferred to a different financial institution, so that a desired financial product can be purchased.

### [Prepaid Card Company]

The financial institution device 50 installed in the prepaid card company includes a fund account DB 51 serving as storage means that stores information regarding the value account of the deposit amount (value) of the prepaid card operated by the prepaid card company.

The information that the fund account DB 51 stores includes attribute information regarding the user for the value account of the prepaid card managed and operated by the prepaid card company, and transaction information regarding, for example, the balance and the deposit and withdrawal history of the value account.

The value account is included in the “fund account” according to the present invention that is the transfer source of the transfer fund for the target amount that the user accumulates.

A fractional amount less than the predetermined set amount in the balance amount in the value account results in the “transfer amount” according to the present invention.

Here, examples of the card operated by the prepaid card company include a retailer-affiliated prepaid card, a transportation-affiliated prepaid card, and various electronic money cards and point cards. Any card allowing payment and settlement in the range of a previously deposited (charged) amount (value) may be used as the prepaid card in the present system.

The information stored in the fund account DB 51 for management of the value account every user, is transmitted to the fractional fund transfer and accumulation server through the network, and then is stored as the account information regarding each user in the account information DB 23.

The financial institution device 50 includes an accumulation account DB 52 serving as storage means that stores information regarding the “accumulation account” (fund saving account) according to the present invention, that is the transfer destination of the transfer fund for the target amount that the user accumulates, from the value account of the prepaid card operated by the prepaid card company.

The accumulation account is an account for accumulation and saving of the transfer fund according to the present invention. Thus, a special account not allowing the user to make a deposit and a withdrawal, such as a dedicated account managed by the prepaid card company, is allocated to the accumulation account. The accumulation account is included in the “accumulation account” according to the present invention that is the transfer destination of the transfer fund for the target amount that the user accumulates.

The information that the accumulation account DB 52 stores includes attribute information regarding each user who uses the account, and for example, the balance and transaction information such as the deposit and withdrawal history of the accumulation account every user.

The transaction information stored in the accumulation account DB 52 results in predetermined information including a result of the transfer fund for the target amount that the user accumulates, and is transmitted to the fractional fund transfer and accumulation server 10.

The financial institutions equipped with the financial institution devices 30 to 50 above each has its own financial institution system or can store and manage, for example, information regarding investment products and loan products on sale from the financial institution, attribution information regarding the users in the financial institution, account transaction history information, access history information, card usage breakdown information, and deposit and withdrawal information, with an external financial institution backbone system.

Such a financial institution system or a financial institution backbone system functions as an accounting-and-informational information processing system of the corresponding financial institution.

Note that, for example, the financial institution backbone system is achieved and managed by a huge server system group owned by an information system enterprise that is a so-called system integrator that receives, in response to outsourcing from one or not less than two financial institutions, as business, a contract for management of a data system for each financial institution. As the financial institution backbone system 50 above, for example, a securities backbone system (STAR (registered trademark)) and a bank financial product intermediary system (BESTWAY (registered trademark)) managed by Nomura Research Institute, Ltd. have been known.

### [Customer Terminal 60]

The customer terminal 60 is an information processing device available to the users (customers or investors) of the financial institutions (the credit card company, the bank, and the prepaid card company) described above. Examples of the customer terminal 60 include a smartphone, a mobile terminal, a PC, and a tablet self-owned by a user, and PCs and dedicated terminal devices installed on the financial institution side on which the financial institution devices 30 to 50 are located.

An operation of the user on the customer terminal 60 enables a call for the program provided by the fractional fund transfer and accumulation server 10. Thus, functions and services provided in the fractional fund transfer and accumulation system according to the present invention can be performed and used.

Note that, in the example illustrated in FIG. 1, only one customer terminal 60 is illustrated. Needless to say, a plurality of customer terminals 60 may be provided in the present system.

Specifically, the customer terminal 60 according to the present embodiment includes target amount setting means 61, fund calculation rule setting means 62, and display means 63.

In accordance with an input operation of the user through input means of the customer terminal 60, the target amount setting means 61 sets information regarding, for example, the target amount that is the reserving target that the user finally saves in the present system, the target period for saving of the target amount, and the monthly target saving amount.

In accordance with an input operation on the customer terminal 60, the fund calculation rule setting means 62 sets predetermined fund calculation rule information for saving of the target amount.

Here, the fund calculation rule information settable by the fund calculation rule setting means 62 includes, as described later, various rules for achievement of a predetermined target amount that is a target in reserving amount (e.g., fractional rules, economization rules, time rules, and other rules) (refer to FIG. 3 to be described later).

The display means 63 is a display unit or a display included in the customer terminal 60. Examples of the display means 63 include a touch panel display unit in a smartphone or a tablet, and a liquid crystal display connected to a PC. The predetermined accumulated fund information generated by the accumulated fund information generation means 13 in the fractional fund transfer and accumulation server 10 described above is displayed visibly to the user through the display means 63.

Here, the accumulated fund information to be output and displayed by the display means 63 includes predetermined information indicating, for example, the amount of money of the current accumulated fund in the accumulation account of the financial institution device 40 or 50 in which the transfer processing instructed and performed by the fractional fund transfer and accumulation server 10 described above is performed (refer to FIGS. 6, 12, and 14 to be described later).

As above, with the customer terminal 60, the user according to the present embodiment accesses a Web application or the like provided by the fractional fund transfer and accumulation server 10 through the Internet or the like, so that the function of the fractional fund transfer and accumulation system according to the present invention can be performed.

Note that, other than the configuration in the present embodiment, for example, direct communication with the financial institution devices 30 to 50 with dedicated software introduced and installed in the customer terminal 60, enables performance of the function of the fractional fund transfer and accumulation system according to the present invention. In this case, the customer terminal 60 itself serves as the fractional fund transfer and accumulation server 10.

For example, introduction of dedicated software to the financial institution devices 40 and 50 enables direct performance of the function of the fractional fund transfer and accumulation system according to the present invention between the financial institution devices 40 and 50 and the customer terminal 60. In this case, the financial institution devices 40 and 50 serve as the fractional fund transfer and accumulation server 10.

### [Sales Company Device 70]

The sales company device 70 is an information processing device installed in a predetermined sales company or maker (hereinafter, referred to as a “sales company”). The sales company device 70 provides and transmits predetermined offer information to the fractional fund transfer and accumulation server 10 through the network.

Here, the sales company is an enterprise, such as a travel agency, an Internet-shopping company, an real estate company, a car dealer, or a condominium developer, that provides and sells a product, a service, or the like that the user in the present system desires for purchase as a target and goal. The sales company is equipped with the sales company device 70 as an information processing device connected to the fractional fund transfer and accumulation server 10 such that data communication is allowable.

Note that, in the example illustrated in FIG. 1, only one sales company device 70 is illustrated. Needless to say, a plurality of sales company devices 70 may be provided in the present system.

Each sales company device 70 transmits the predetermined offer information to the fractional fund transfer and accumulation server 10, so that the offer information is provided to the customer terminal 60 through the fractional fund transfer and accumulation server 10.

Here, the offer information to be provided from each sales company device 70, includes WEB information including text and images indicating, for example, the contents and prices of products or services that the sales company provides, and URL. The offer information includes an offer of the point (sponsor point) to be provided to the users in the present system.

As described above, the predetermined point is granted to the user who has browsed the appropriate offer information (refer to FIG. 21).

With such granting of the sponsor point, each sales company provides point granting on condition of user registration or the like, so that information regarding, for example, the personal information or interest and taste of the user can be collected.

For example, a user who has set the target amount with “overseas travel” as a goal browses the offer information from the travel agency. In that case, the sponsor point available for travel costs can be provided, and a request can be made for provision of information regarding, for example, the name, address, telephone number, e-mail address, desired travel destination, budget, and set target amount of the user, as the condition of point granting.

As a result, the sales company that has received the provision of the personal information as described above from the user can carry out accurate promotion activities, such as advertising campaign, to the user.

Note that such transmission and provision of user information to the sales company device 70 is performed after permission and approval of the user is obtained in advance.

For the information regarding the user to be provided to the sales company device 70, for example, selection and setting of the user enables provision of only specific information (e.g., the e-mail address), so that important information, such as the address and the telephone number, can be prevented from being provided.

Furthermore, the financial institution devices 30 to 50 installed in the financial institutions of the credit card company, the bank, and the prepaid card company described above can be made to operate as the sales company device 70. For example, the bank can carry out promotion activities regarding home loans. In this case, the sales company device 70 may operate as the financial institution device 40 at the bank, or the financial institution device 40 may have the function of the sales company device 70.

### [Fractional Fund Transfer and Accumulation Method]

Next, the specific processing operation of the fractional fund transfer and accumulation system 1 according to the present embodiment having the above configuration (fractional fund transfer and accumulation method) will be described with reference to FIGS. 3 to 22.

First, as a precondition for the processing operation of the fractional fund transfer and accumulation system 1, in accordance with an input operation of the user, predetermined fund calculation rules are set from the customer terminal 60 to the fractional fund transfer and accumulation server 10.

FIG. 3 is an explanatory illustration of exemplary “fund calculation rules” settable in the fractional fund transfer and accumulation server 10 according to the present embodiment.

### [Fund Calculation Rules]

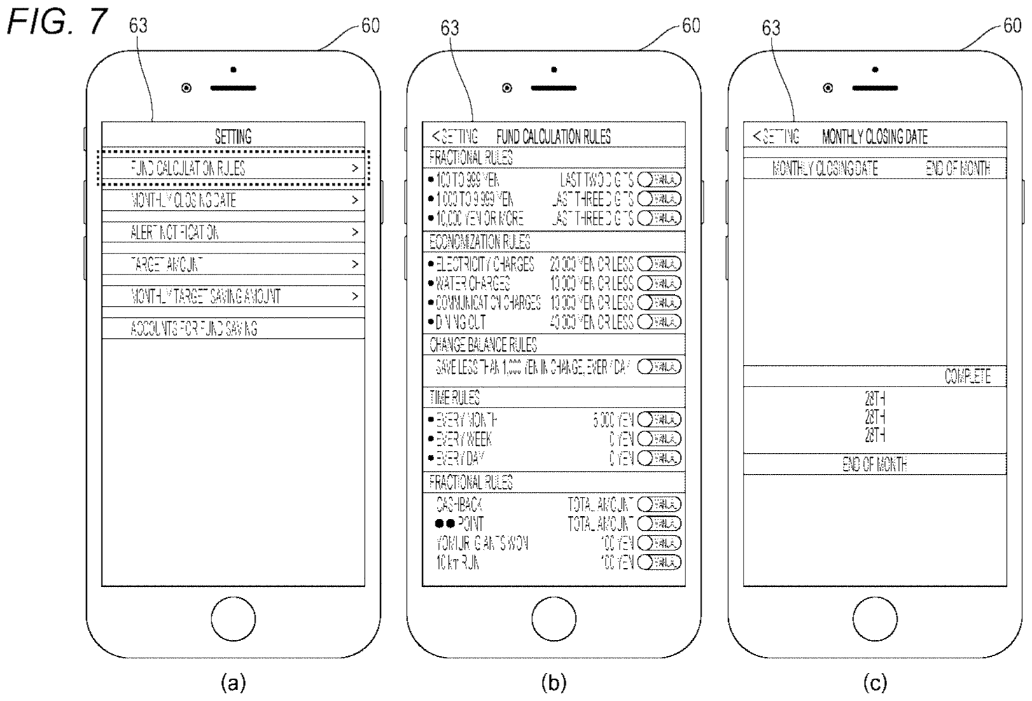

For setting of the fund calculation rules, the user opens a predetermined screen for “fund calculation rules” (refer to FIG. 7(b)) on a dedicated application or a designated website through the customer terminal 60 operable by the user (e.g., a smartphone or a PC), so that the user can perform various types of setting. The set fund calculation rules are stored in the fund calculation rule DB 22 on the fractional fund transfer and accumulation server 10 side.

According to the present embodiment, for achievement of an arbitrary “target amount” set by the user (refer to FIGS. 3 and 16 to 19), as illustrated in FIG. 3, “fractional rules”, “economization rules”, “change balance rules”, “time rules”, and “other rules” are set as the fund calculation rules.

Specifically, in the example illustrated in FIG. 3, the following “rules” can be set for achievement of the predetermined “target amount”. The amount of money computed in accordance with the set rules is to be transferred from a predetermined fund account to the accumulation account as the “transfer fund”, and is subjected to transfer processing either in “auto” transfer mode or in “manual” transfer mode.

### [Fractional Rules]

Deduction of 100 to 999 yen: the last two digits of the difference from 1,000 yen⋅manual
Deduction of 1,000 to 9,999 yen: the last three digits of the difference from 10,000 yen⋅manual
Deduction of 10,000 yen or more: the last three digits of the difference from a unit of 10,000 yen⋅manual

### [Economization Rules]

Electricity charges: difference from 20,000 yen⋅auto
Water charges: difference from 10,000 yen⋅auto
Communication charges: difference from 10,000 yen⋅auto
Dining out: difference from 40,000 yen⋅auto

### [Change Balance Rules]

Every day: save less than 1,000 yen in change⋅auto

### [Time Rules]

Every month: 5,000 yen⋅auto
Every week: 0 yen⋅auto
Every day: 0 yen⋅auto

### [Other Rules]

Cashback: total amount⋅auto
●● point: total amount⋅auto
The Yomiuri Giants won: 100 yen⋅auto
10 Km run: 100 yen⋅auto

With the “fund calculation rules” set as above, when a deduction made from the deduction account after the user uses the credit card for daily shopping or the like, on the basis of the “fractional rules”, the fund calculation means 11 first computes a fraction equivalent to the change due to a payment made in cash with bills. Then, the amount of money of the fraction is transferred as the transfer fund from the fund account to the accumulation account. For example, for a deduction of “4,860 yen”, the fund calculation means 11 performs calculation processing of “5,000 yen−4860 yen=140 yen”, resulting in a transfer fund of “140 yen”.

Note that usage and deduction of the credit card is referred to and discriminated by the fund calculation means 11 on the basis of card usage breakdown information transmitted from the financial institution device 30 at the credit card company.

On the basis of the “economization rules”, the fund calculation means 11 computes, as an economization amount, the difference from the set amount for utility costs, such as electricity charges, public utility charges, or dining out. Then, the amount of money of the difference is transferred as the transfer fund from the fund account to the accumulation account. For example, in a case where “20,000 yen” is set as the set amount of the “electricity charges” and the deduction of electricity charges of a month is “15,220 yen”, the fund calculation means 11 performs calculation processing of “20,000 yen−15,220 yen=4,780 yen”, resulting in a transfer fund of “4,780 yen”.

Therefore, for example, in a case where the deduction amount of the electricity charges exceeds the set amount (20,000 yen), no transfer fund is computed, so that no transfer processing is performed.

Note that the fund calculation means 11 refers to and discriminates deduction of the utility costs and public utility charges, on the basis of deduction information transmitted from the financial institution device 40 at the bank or on the basis of card usage breakdown information transmitted from the financial institution device 30 at the credit card company for usage of the credit card.

Deduction of the dining out is discriminated on the basis of the card usage breakdown information of the credit card described above. For example, in a case where a business-type code can be acquired from the card usage breakdown information of the credit card company, a discrimination can be made with the business-type code. In a case where no business-type code is available, a discrimination can be made with the name of a shop or the like. The user can designate a breakdown to be classified in the dining out, from the existing card breakdowns.

On the basis of the “change balance rules”, the fund calculation means 11 computes an amount of money of less than 1,000 yen as a fraction in the balance in a case where the balance remains in the deposit amount (value) after the user makes payment and settlement with the prepaid card for daily shopping or the like, as a fraction equivalent to the change due to a payment made in cash with bills. The amount of money is transferred as the transfer fund from the fund account to the accumulation account. For example, in a case where the balance of the prepaid card on the day is “1,865 yen”, the fund calculation means 11 performs calculation processing of “1,865 yen−1,000 yen=865 yen”, resulting in a transfer fund of “865 yen”.

The fund calculation means 11 refers to and discriminates balance information regarding the prepaid card, on the basis of transaction information (balance information) regarding the prepaid card transmitted from the financial institution device 50 at the prepaid company.

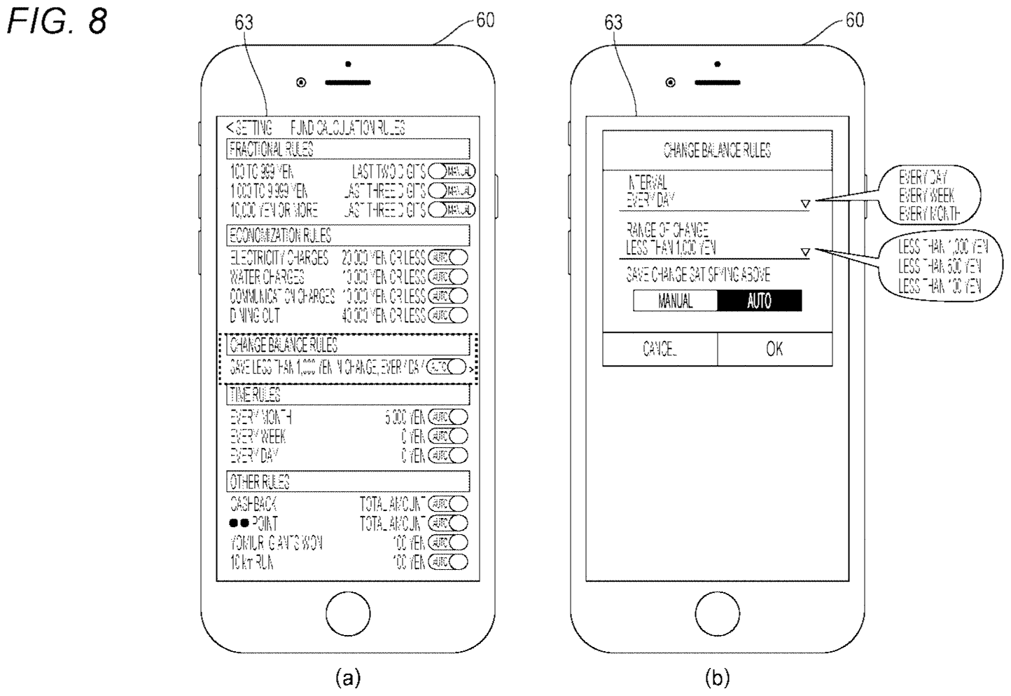

Note that, according to the present embodiment, the change satisfying “every day: less than 1,000 yen” is transferred as the “change balance rules”. Instead of this, another rule, such as “every week: less than 100 yen” or “every month: less than 500 yen” may be set as a matter of course (refer to FIG. 8).

Setting of the “time rules” enables a predetermined fixed amount set by the user, to be transferred to the accumulation account every predetermined cycle, such as every month, every week, or every day.

Although this transfer is almost the same as the existing cumulative deposits or the like, a smaller amount of transfer is allowed and various types of cycle setting can be made in comparison to the cumulative deposits. Thus, advantageously, the degree of freedom in the amount of money or in period is enhanced, and the user can steadily reserve a small amount of fund effortlessly.

Furthermore, as the “other rules”, for service of cashback or point granting, the cashback or the point granting can be directly all transferred to the accumulation account instead of receiving the service.

The user can set rules optionally. In a case where a predetermined event occurs, for example, a favorite sport team (e.g., the Yomiuri Giants or the Urawa Red Diamonds) has won, the user can reserve a certain amount of money (e.g., 100 yen), so that the effect that the user can enjoy reserving is obtained.

Note that, the presence or absence of occurrence of such an event can be determined by, for example, input of the appropriate event information from a news site on the Internet.

For the predetermined event appropriate to the “other rules”, in a case where the user has achieved, for example, a target (e.g., a 10 Km run by running or 10,000 steps by walking, in which the user can set an arbitrary numerical value for the target), a certain amount of money (e.g., 100 yen) can be reserved as a reward (pay) to the user. This arrangement enables further increase of the pleasure of the user in reserving, in combination with the feeling of achievement of the user to the target, such as the running.

Note that, for the distance of running or the number of steps of the user, a distance can be measured with a device capable of identifying running, such as a wearable terminal or a smartphone terminal. Measured distance data can be acquired through an application in the fractional fund transfer and accumulation server 10.

For the transfer of the fund based on the rules set as described above, either the “manual” mode or the “auto” mode can be selectively set as the transfer mode.

In a case where the fund transfer mode is set to the “manual”, when an amount of money to be transferred is extracted, it is displayed that the amount of money is to be transferred. In accordance with an input operation of the user, the fund transfer instruction means 12 issues a transfer instruction (refer to FIGS. 6, 12, and 14 to be described later). Therefore, decision of the user enables the transfer processing not to be performed, for example, depending on the fund situation (user's financial condition).

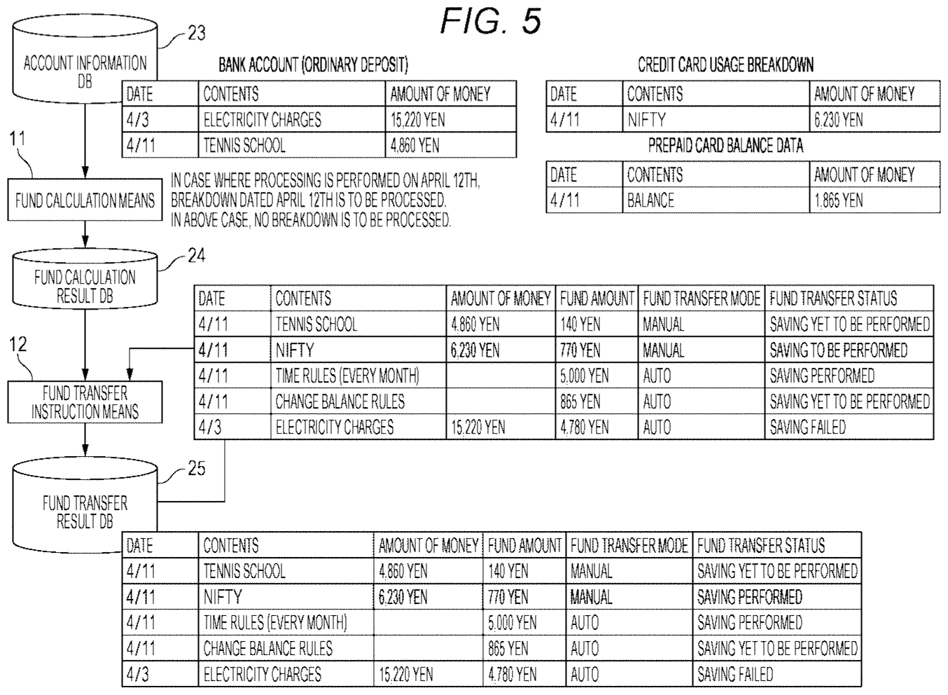

In this case, the fund transfer status indicates “saving yet to be performed” until the user makes a “manual” operation. In a case where the transfer processing is performed by a “manual” operation, the fund transfer status results in “saving performed”. In a case where no transfer processing is performed due to an insufficient balance in the account, the fund transfer status results in “saving failed” (refer to FIGS. 4 and 5 to be described later).

Meanwhile, in a case where the fund transfer mode is set to the “auto”, when an amount of money to be transferred is extracted, the fund transfer instruction means 12 automatically issues a transfer instruction. Note that, in this case, for an insufficient balance in the fund account at the bank, no transfer processing is performed. A predetermined announcement (e.g., an alert notification) indicating the insufficient balance can be issued.

For no deposit amount (zero) at the prepaid card company, no transfer processing of “change balance” is performed.

Furthermore, in the “auto”, for extraction of an amount of money to be transferred, the deduction record in the bank account and the credit card usage breakdown record are to be processed. The amount of money can be extracted from the content (a subject of deduction and a subject of breakdown) or can be extracted from the company name of a payee. Here, classification in content may be performed on the basis of the content and the company name of a payee, and determination of whether extraction is to be performed may be performed in accordance with the classified content.

In this case, when the transfer processing is performed in the “auto”, the fund transfer status results in “saving performed”. In a case where no transfer processing is performed due to an insufficient balance in the account, the fund transfer status results in “saving failed” (refer to FIGS. 4 and 5 to be described later).

### [Operation]

Exemplary operations of the fractional fund transfer and accumulation system 1 according to the present embodiment, with the “fund calculation rules” set as above will be described with reference to FIGS. 4 and 5.

FIGS. 4 and 5 are explanatory illustrations of the exemplary operations of the fractional fund transfer and accumulation system 1 according to the present embodiment.

As illustrated in FIG. 4, in the fractional fund transfer and accumulation server 10, first, the information regarding the bank account, the card usage breakdown, and the balance of the prepaid card, stored in the account information DB 23, is periodically referred to. The fund calculation means 11 performs fund calculation, in accordance with the fund calculation rules set in the fund calculation rule DB 22. Then, a result of the fund calculation is output and stored into the fund calculation result DB 24.

Note that, for the account information stored in the account information DB 23, necessary information transmitted at a predetermined timing (e.g., daily processing) from the financial institution device 30 at the credit card company, the financial institution device 40 at the bank, and the financial institution device 50 at the prepaid card company causes the information in the account information DB 23 to be updated.

The processing operation on April 11th is indicated in the example illustrated in FIG. 4. Deduction information on “April 3rd: electricity charges⋅15,220 yen” and “April 11th: tennis school⋅4,860 yen” that are transactions in the ordinary deposit account of the user, transmitted as the account information from the financial institution device 40 at the bank, usage breakdown information on “April 11th: NIFTY⋅6,230 yen” transmitted as the card usage breakdown information from the financial institution device 30 at the credit card company, and balance data information on “April 11th: 1,865 yen” transmitted as the transaction information regarding the prepaid card from the financial institution device 50 at the prepaid card company are stored as the account information in the account information DB 23.

In this state, the fund calculation means 11 performs fund calculation processing at a predetermined timing (e.g., every day, twice a day). The fund calculation processing may be performed at the timing of reception of the transaction information as a matter of course.

For the fund calculation processing, predetermined calculation processing is performed with reference to the previously set “fund calculation rules” described above.

In the example illustrated in FIG. 4, as the fund calculation processing on April 11th, calculation and discrimination of “fund amount: 140 yen⋅fund transfer mode: manual⋅fund transfer status: saving yet to be performed” is performed for the “April 11th: tennis school⋅4,860 yen”, and calculation and discrimination of “fund amount: 770 yen⋅fund transfer mode: manual⋅fund transfer status: saving yet to be performed” is performed for “April 11th: NIFTY⋅6,230 yen”, on the basis of the “fractional rules”.

On the basis of the “time rules”, calculation and discrimination of “April 11th: time rules (every month)⋅fund amount 5,000 yen⋅fund transfer mode: auto⋅fund transfer status: saving yet to be performed” is performed.

Furthermore, on the basis of the “change balance rules”, calculation and discrimination of “April 11th: change balance rules⋅fund amount 865 yen⋅fund transfer mode: auto⋅fund transfer status: saving yet to be performed” is performed.

A result of the calculation by the fund calculation means 11 is stored in the fund calculation result DB 24.

After that, on the basis of the fund calculation result information stored in the fund calculation result DB 24, the fund transfer instruction means 12 transmits the fund transfer instruction information to the financial institution device 40 at the bank and the financial institution device 50 at the prepaid card company.

According to the fund transfer instruction, a breakdown in which the fund transfer mode is set to the “auto” or the fund transfer status is set to the “saving to be performed”, in the fund calculation result DB 24 is to be processed (refer to FIG. 5).

In a case where the fund transfer mode is set to the “manual”, no fund transfer instruction is transmitted before a manual operation of the user.

Transmission of the fund transfer instruction causes the financial institution device 40 at the bank being a target to perform transfer processing to a different account (accumulation account) in the bank within the range of the balance in the appropriate fund account (e.g., an ordinary deposit account). The financial institution device 50 at the prepaid card company being a target performs transfer processing of a fractional amount less than 1,000 yen in the balance in the appropriate fund account (value account of the prepaid card), to a different account (accumulation account) in the prepaid card company.

After that, the fractional fund transfer and accumulation server 10 acquires results of the transfer instruction transmitted at a predetermined timing after transmission of the transfer instruction to the financial institution devices 40 and 50. Then, information regarding the results is stored in the fund transfer result DB 25.

Note that the results of the transfer processing from the financial institution devices 40 and 50 are transmitted in real time during the transfer processing. Alternatively, notifications of the results can be received from the financial institution devices 40 and 50, at a predetermined timing after the transfer processing of each financial institution finishes. Until acquisition of the transfer results from the financial institution devices 40 and 50, the fund transfer status on the fractional fund transfer and accumulation server 10 side remains in the “saving yet to be performed”.

In the example illustrated in FIG. 4, for “April 11th: tennis school⋅4,860 yen⋅fund amount: 140 yen⋅fund transfer mode: manual” and “April 11th: NIFTY⋅6,230 yen⋅fund amount: 770 yen⋅fund transfer mode: manual”, no fund transfer instruction is issued, and thus the fund transfer status remains in the “saving yet to be performed”.

Meanwhile, for “April 11th: time rules (every month)⋅fund amount 5,000 yen⋅fund transfer mode: auto” and “April 11th: change balance rules⋅fund amount 865 yen⋅fund transfer mode: auto”, the fund transfer instruction is issued. As a result, the fund transfer status indicates the “saving performed”.

As illustrated in the figure, for “April 3rd: electricity charges⋅15,220 yen⋅fund amount: 4,780 yen⋅fund transfer mode: auto”, the fund transfer status indicates the “saving failed”. Thus, it can be seen that no transfer processing has been performed due to an insufficient balance in the account.

In this manner, in accordance with the transfer results from the financial institution devices 40 and 50, the information indicating the fund transfer status changes to the “saving performed” in a case where the transfer has succeeded, and changes to the “saving failed” in a case where the transfer has failed. After the change, the updated information is stored as the fund transfer result information in the fund transfer result DB 25.

The transfer results can be displayed and verified on the screen of the display means 63 of the customer terminal 60 after the transfer processing finishes (refer to FIG. 6).

Then, the fund transfer status indicating the “saving yet to be performed” or the “saving failed” described above can be changed to the “saving to be performed”, on the screen of the customer terminal 60. The fund transfer status changes to the “saving to be performed”, resulting in being to be processed of the next fund transfer instruction. The “saving to be performed” is stored for updating as input data of the fund transfer instruction.

This respect will be described with reference to FIG. 5.

FIG. 5 exemplarily illustrates a case where the fund transfer status is changed to the “saving to be performed” on April 12th that is the next day of the processing illustrated in FIG. 4.

In the processing on April 12th illustrated in FIG. 5, the account information in the account information DB 23 remains unchanged, and the fund calculation means 11 has performed no calculation processing. Therefore, no storage data has changed in the fund calculation result DB 24.

In this state, for “April 11th: NIFTY⋅6,230 yen⋅fund amount: 770 yen⋅fund transfer mode: manual⋅fund transfer status: saving yet to be performed” illustrated in FIG. 4, the user operates the customer terminal 60 to change the fund transfer status to the “saving to be performed”.

In this manner, the change of the fund transfer status from the “saving yet to be performed” (or “saving failed”) to the “saving to be performed” through the customer terminal 60 causes updating of the storage information in the fund transfer result DB 25.

After that, at a predetermined timing, the fund transfer instruction means 12 extracts the appropriate “April 11th: NIFTY⋅6,230 yen⋅fund amount: 770 yen” as being to be processed of the fund transfer instruction. Then, the fund transfer instruction means 12 transmits the fund transfer instruction to the financial institution device 40.

The financial institution device 40 to which the fund transfer instruction has been transmitted performs transfer processing from the appropriate fund account to the accumulation account, and transmits a result of the transfer instruction to the fractional fund transfer and accumulation server 10.

This arrangement causes updating of the information in the fund transfer result DB 25.

In the example illustrated in FIG. 5, for “April 11th: NIFTY⋅6,230 yen⋅fund amount: 770 yen⋅fund transfer mode: manual”, it can be seen that the fund transfer status has been updated from the “saving yet to be performed” to the “saving performed”.

Then, in accordance with a reference demand from the customer terminal 60, a result of the fund transfer processing performed as described above is generated as the accumulated fund information by the accumulated fund information generation means 13. Then, the result can be displayed for browsing by the display means 63 of the customer terminal 60.

FIG. 6 illustrates exemplary display screens of the accumulated fund information displayed by the display means 63 of the customer terminal 60 according to the present embodiment. FIG. 6(a) illustrates the accumulated fund information at the point in time corresponding to FIG. 4, and FIG. 6(b) illustrates the accumulated fund information at the point in time corresponding to FIG. 5.

In the example illustrated in FIG. 6(a), the current “fund amount in saving: 5,865 yen” and the target amount “10,000 yen” are indicated. In addition, the “saving yet to be performed”, the “saving yet to be performed”, the “saving performed”, and the “saving performed” are indicated for “April 11th⋅4,860 yen⋅tennis school⋅+140 yen”, for “April 11th⋅6,230 yen⋅NIFTY⋅+770 yen”, for “April 11th⋅time rules (every month)⋅+5,000 yen”, and for “April 11th⋅change balance rules⋅+865 yen”, respectively.

It is indicated that “−13,121 yen” has been fund-transferred (fund-moved to a financial product) as the purchase fund for a financial product on April 10th that is the previous day.

Furthermore, the “saving failed” is indicated for “April 3rd⋅15,220 yen⋅electricity charges⋅+4,780 yen”.

Meanwhile, although the example illustrated in FIG. 6(b) is almost the same as the screen of FIG. 6(a), “April 11th⋅6,230 yen⋅NIFTY⋅+770 yen” has changed in display from the “saving yet to be performed” to the “saving performed”. In addition, it can be seen that the current “fund amount in saving” has increased from “5,770 yen” to “6,635 yen”.

In this manner, the user can browse and refer to the current accumulated fund and the status of the transfer processing at any time through the customer terminal 60 being operated by the user, and additionally can change the fund transfer status.

Note that, for change of the fund transfer status, for example, a tap operation on an icon display of the “saving yet to be performed” illustrated in FIG. 6(a) enables a switch in setting between the “saving yet to be performed” and the “saving to be performed”.

Similarly, for example, a tap operation on an icon display of the “saving failed” enables a switch to the “saving to be performed”.

For the fund transfer status of the “manual” or the “auto” illustrated in FIGS. 6(a) and 6(b), for example, a tap operation enables a switch between the “auto” and the “manual”.

Although not specifically illustrated in FIGS. 4 to 6 described above, in a case where “electricity charges: 20,000 yen or less” is set as the “economization rules” described above (refer to FIG. 3), when the monthly electricity charges are close to 20,000 yen (e.g., more than 80% of the set amount (16,000 yen)), a predetermined alert can be issued. As the alert notification, for example, predetermined characters or a predetermined warning display can be displayed in an “electricity charges” item on the display screen.

For the timing of the alert notification, for example, a default value can be previously set on the fractional fund transfer and accumulation server 10 side. If necessary, the user can change the default value on a setting screen on the dedicated application or the website. Note that the alert notification can be set to “invalid”.

As described above, for example, in a case where the monthly target saving amount is set, the alert notification can be performed even in a case where the amount of money is unlikely to be attained. Estimation and discrimination of whether the target amount is likely to be attained can be performed in comparison to the previous-month record, for example.

In a case where the target saving amount has been achieved continuously at early stages, a predetermined message can be issued for an increase of the set amount. For example, in a case where a month in which 100% of the set amount is attained before the 20th of the month continues a predetermined number of times (e.g., three times), more efficient reserving meeting the fund status of the user can be suggested with display of the past records together with display of a message indicating “Would you like to attempt a target amount of 15,000 yen?” with an amount of money acquired by addition of the current target amount and a predetermined amount of money, set as a new target amount.

When the transfer amount in the accumulation account of the financial institution device 40 attains a predetermined amount of money by the processing operation of the fund transfer as described above, purchase processing of a predetermined product (fund movement) with the transfer fund, for example, purchase and order processing of a financial product or a product, a service, or the like registered on the wish list, is performed.

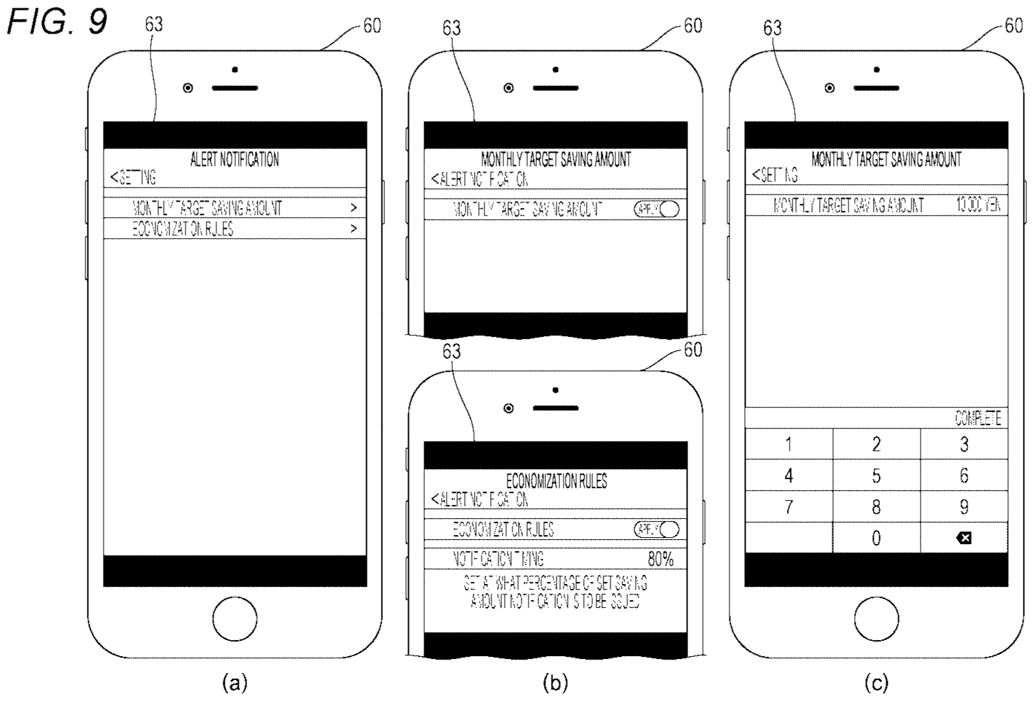

Here, for purchase of a financial product, for example, in a case where the amount of money in the accumulation account on the set “monthly closing date” (refer to FIG. 7(c)) exceeds the “monthly target saving amount” (refer to FIG. 9(c)), purchase of a predetermined financial product (fund movement) can be performed once a month.

Thus, the user can shift the accumulated fund resulting from saving of daily fractional funds or economization funds to a financial product enabling acquisition of a more advantageous dividend or yield, so that efficient asset management or the like is achieved.

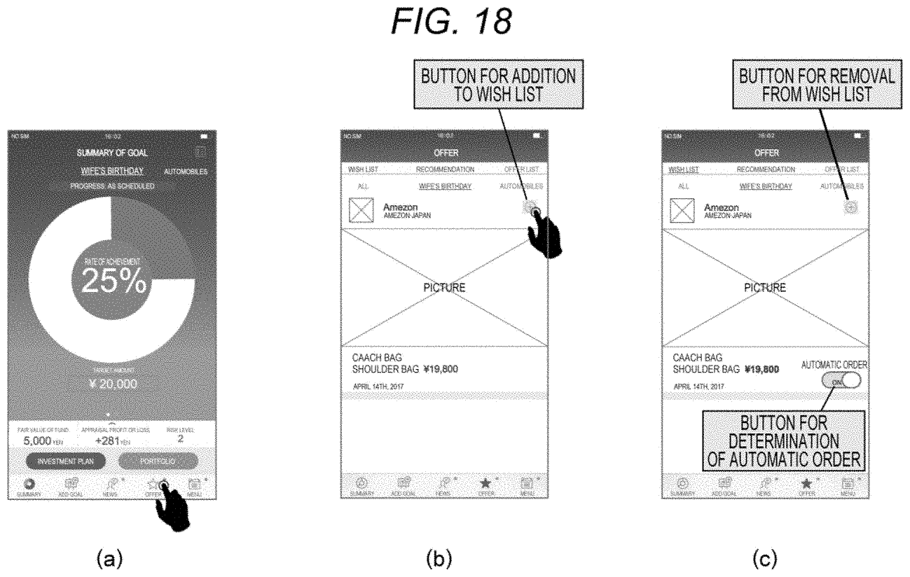

Order processing of a product, a service, or the like registered on the wish list will be described later with reference to FIGS. 18 to 18.

### [Setting Display Screens]

Next, FIGS. 7 to 9 illustrate exemplary input display screens for setting items to the fractional fund transfer and accumulation server 10, the setting items being able to be input and set on the customer terminal 60 side in the fractional fund transfer and accumulation system 1 as above.

FIG. 7(a) is a screen selectably displaying various setting items settable to the fractional fund transfer and accumulation server 10.

As illustrated in the figure, selection of the respective items of “fund calculation rules”, “monthly closing date”, “alert notification”, “target amount”, “monthly target saving amount”, and “accounts for fund saving” from the screen enables detailed setting of the respective items.

FIG. 7(b) is a setting screen for the “fund calculation rules” selected on the screen of FIG. 7(a).

The screen enables selection and setting of the necessity of the respective items of “fractional rules”, “economization rules”, “change balance rules”, “time rules”, and “other rules” as the “fund calculation rules” described above, and selection and setting of the “manual” or the “auto” in fund transfer mode for each item.

FIG. 7(c) is a setting screen for the “monthly closing date”.

The criterial date for performance of monthly-closing processing to the reserving fund transferred to the accumulation account can be set from the screen. In the figure, “end of the month” is selected and set as the monthly closing date.

FIG. 8(a) is a setting screen for the “fund calculation rules” similar to that of FIG. 7(b).

FIG. 8(b) is a setting screen for the “change balance rules” selected on the screen of FIG. 8(a).

The screen enables selection and setting of the respective items of “interval” and “range of change” as the “change balance rules” described above and selection and setting of the “auto” or the “manual” in fund transfer mode for the set “change balance rules”.

Because the balance of the deposit amount is recorded in fractional saving with the prepaid card, differently from the credit card or the debit card, a change portion in the balance is allocated to saving or a principal for investment.

In the present system, specifically, “every day”, “every week”, or “every month” can be set as the interval for calculation of change. The change is calculated at the end of the day (e.g., at 0 a.m.) for the “every day”, at the end of the week (e.g., at 0 a.m. on the Sunday) for the “every week”, and at the end of the month (e.g., at 0 a.m. on the last day of the month) for the “every month”.

For the range of change, “less than 1,000 yen”, “less than 500 yen”, and “less than 100 yen” are provided. Specifically, in a case where the balance of the prepaid card at the end of a day (week or month) is “1,734 yen”, “734 yen” results in the change with the “range” set to the “less than 1,000 yen”, “234 yen” results in the change with the “range” set to the “less than 500 yen”, and “34 yen” results in the change with the “range” set to the “less than 100 yen”. Then, the amount of money of the change is allocated as the transfer fund to accumulate and save.

FIG. 9(a) is a setting screen for the “alert notification”.

As illustrated in the figure, according to the present embodiment, the “alert notification” can be set to each of the “monthly target saving amount” and the “economization rules”.

In a case where the “alert notification” is set to the “monthly target amount” (refer to FIG. 9(b)), predetermined alert notification can be performed in a case where it is estimated and determined that the monthly target amount is unlikely to be attained. In a case where the “alert notification” is set to the “economization rules”, predetermined alert notification can be performed in a case where a predetermined ratio (e.g., 80% of the set amount) is attained to the upper limit amount (economization amount) set as the “economization rules”, for example, “electricity charges: 20,000 yen or less” or “dining out: 40,000 yen or less” (refer to FIG. 9(b)).

FIG. 9(c) is a setting screen for the “monthly target saving amount”.

The screen enables setting of the “monthly target saving amount” of the transfer fund to the accumulation account with the fractional fund transfer and accumulation system 1 (target amount according to the present invention).

### [Setting of Plurality of Accounts]

In the fractional fund transfer and accumulation system 1 according to the embodiment of the present invention as above, for the accumulation account for accumulation of the transfer fund, one (single) user can set a plurality of accumulation accounts.

FIG. 10 illustrates exemplary display screens on which a plurality of accumulation accounts is set on a setting screen of the customer terminal 60. FIG. 10(a) illustrates “create a new account for fund saving” selected on a setting screen for the “accounts for fund saving” selected in FIG. 7(a). FIG. 10(b) illustrates a screen in a case where an account for “fund raising” has been created as a result. FIG. 10(c) illustrates a setting screen for the account for “fund raising” selected and set in FIG. 10(b).

Such setting from the customer terminal 60 causes a plurality of accumulation accounts to be allocated to, for example, a separate deposit and a pool account at the financial institution.

In the example illustrated in FIG. 10, as the “accounts for fund saving”, an account for “fund raising” is provided in addition to a main account for “standard”. Predetermined point granting (●● point) causes transfer processing to be performed in the “auto” into the account for “fund raising”.

In this manner, according to the present embodiment, in accordance with purposes of reserving, target amounts, or object to be economized, a plurality of accumulation accounts can be provided, such as the account for “standard” for pure fund reserving and the account for “fund raising”. Thus, a various types of reserving or economization can be performed.

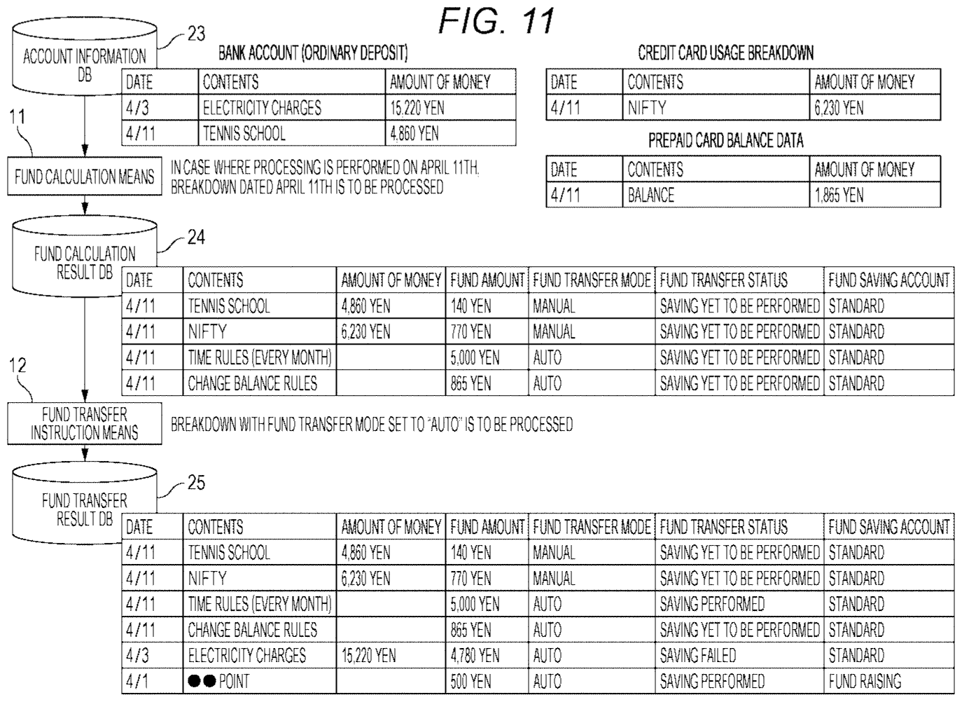

A transfer processing operation for two accounts for “standard” and “fund raising” set as accumulation accounts will be described below with reference to FIGS. 11 to 14.

FIG. 11 illustrates a case where deduction transaction corresponding to FIG. 4 described above is performed with the account for “fund raising” set in addition to the account for “standard”. In comparison to the case of FIG. 4, information (item) indicating which accumulation account should be designated is added to each deduction transaction.

That is, in the example of FIG. 11, with bank transaction, credit card usage, and prepaid card balance similar to those in the case of FIG. 4 described above, processing with “fund saving account: standard” is performed for the respective deduction transactions of “April 11th: tennis school⋅4,860 yen⋅fund amount: 140 yen”, “April 11th: NIFTY⋅6,230 yen⋅fund amount: 770 yen”, “April 11th: time rules (every month)⋅fund amount 5,000 yen”, “April 11th: change balance rules⋅865 yen”, and “April 3rd: electricity charges: 15,220 yen⋅fund amount: 4,780 yen”.

In addition, because of “fund saving account: fund raising” set for “April 1st: ●● point⋅500 yen”, it can be seen that the total amount is automatically transferred to the account for “fund raising”.

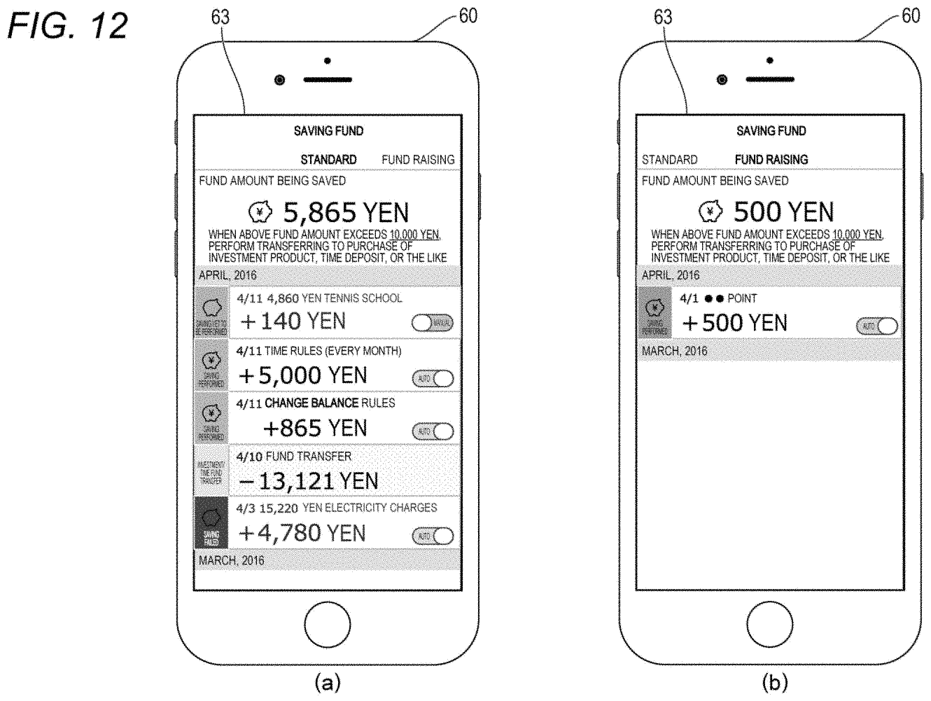

The transfer results can be displayed and verified on the screen of the display means 63 of the customer terminal 60 (refer to FIG. 12).

FIG. 12(a) illustrates the current saving status of the account for “standard” on April 11th. The saving status is similar in content to that illustrated in FIG. 6(a) described above.

Meanwhile, FIG. 12(b) illustrates the current saving status of the account for “fund raising” on April 11th. “April 1st: ●● point⋅+500 yen” is indicated with “saving performed” due to the “auto” processing.

Note that the switch in display screen between the account for “standard” and the account for “fund raising” (accumulated fund reference information) can be performed by, for example, a swipe operation to a predetermined portion on the display screen (character portion of “standard” and “fund raising” at the upper portion of each display screen of FIG. 12).

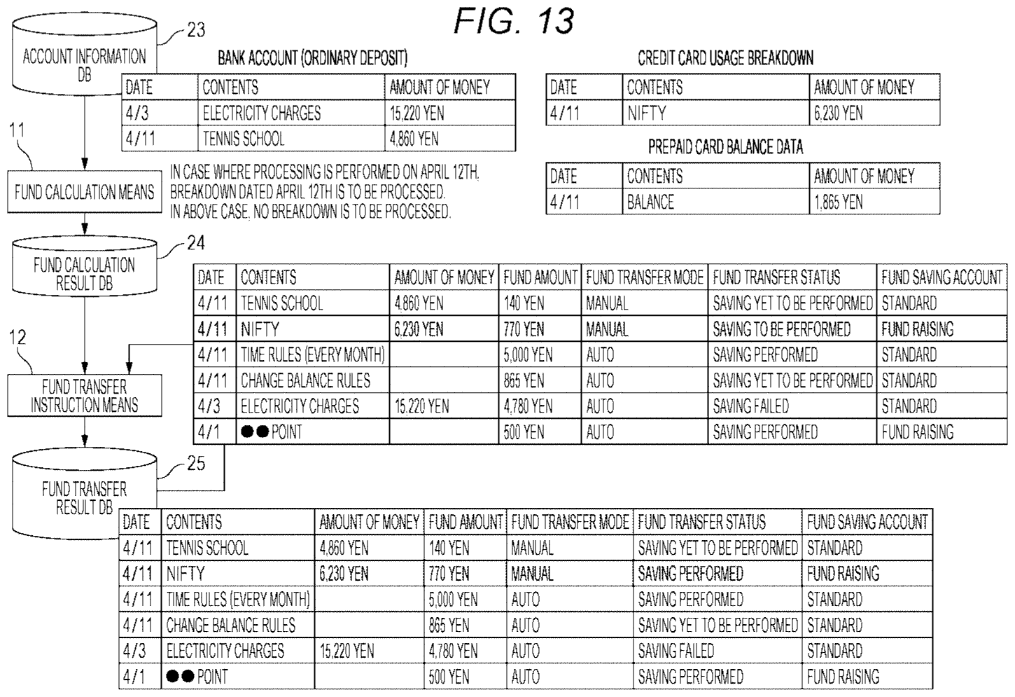

FIG. 13 illustrates a case where deduction transaction corresponding to FIG. 5 described above is performed with the account for “fund raising” set in addition to the account for “standard”.

In the example illustrated in the figure, with bank transaction and card usage similar to those in the case of FIG. 5 described above, the fund transfer status has changed to “saving to be performed” for “April 11th: NIFTY⋅6,230 yen⋅fund amount: 770 yen⋅fund transfer mode: manual⋅fund transfer status: saving yet to be performed” illustrated in FIG. 11. Furthermore, the accumulation account to be designated has changed from “standard” to “fund raising”.

For change of the accumulation account, for example, in a case where “saving yet to be performed” is changed to “saving to be performed”, generation and display of a display screen on which the account to be used is selectable, enables selection of either the account for “standard” or the account for “fund raising”.

In this manner, an input operation from the customer terminal 60 enables change of “saving yet to be performed” to “saving to be performed” and selection and change of the account to be designated. This arrangement enables provision of more flexible various reserving patterns and economization patterns.

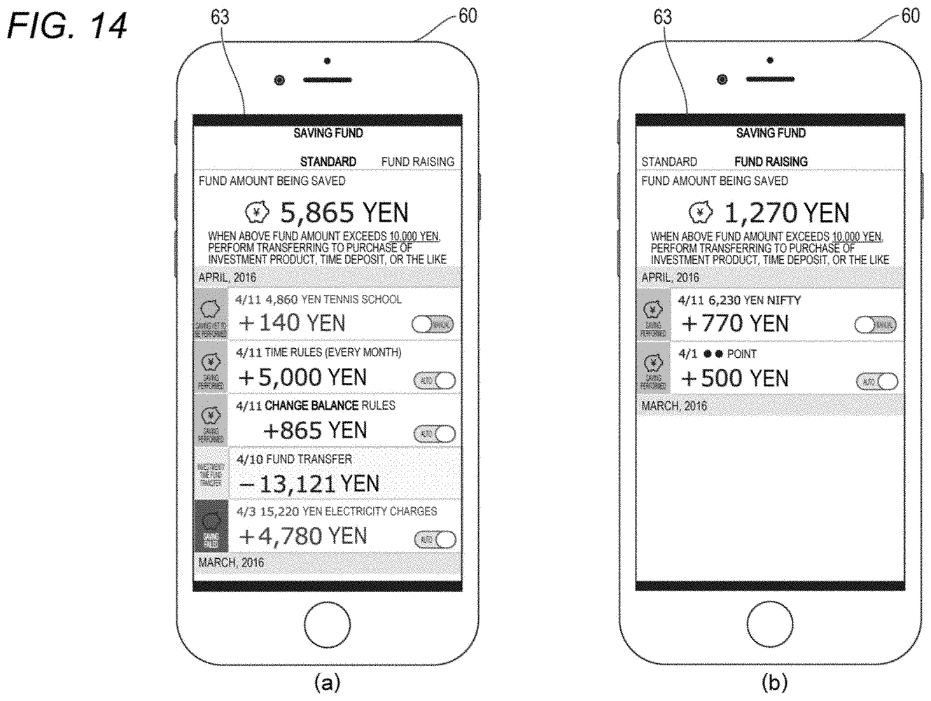

Note that the transfer result can be displayed and verified on the screen of the display means 63 of the customer terminal 60 (refer to FIG. 14).

FIG. 14(a) illustrates the current saving status of the account for “standard” on April 12th. The saving status is similar in content to that illustrated in FIG. 6(a) described above.

Meanwhile, FIG. 14(b) illustrates the current saving status of the account for “fund raising” on April 12th. “April 11th⋅6,230 yen⋅NIFTY⋅+770 yen” is indicated with “saving performed” due to the “manual” processing in addition to “April 1st: ●● point⋅+500 yen”. An increase to “fund amount in saving: 1,270 yen” can be verified and referred to.

### [Sharing Account Setting]

As described above, in the fractional fund transfer and accumulation system 1 according to the present embodiment, one user can set a plurality of accumulation accounts for reserving.

Furthermore, according to the present embodiment, a plurality of users can set one (sharing) accumulation account.

For example, a family of three people can reserve a fractional fund or an economization fund into one accumulation account.

FIG. 15 illustrates exemplary display screens on which one accumulation account to be shared by a plurality of users is set on a setting screen of the customer terminal 60. FIG. 15(a) illustrates “create a new account for fund saving” selected on a setting screen for the “accounts for fund saving” selected in FIG. 7(a). FIG. 15(b) illustrates a screen in a case where an account for “sharing” has been created as a result. FIG. 15(c) illustrates a setting screen for the account for “sharing” selected and set in FIG. 15(b).

Such setting from the customer terminal 60 causes a plurality of users to be allocated to one accumulation account set to, for example, a separate deposit or a pool account at the financial institution.

In the example illustrated in FIG. 15, as the “accounts for fund saving”, the account for “sharing” is separately provided in addition to the account for “standard” and the account for “fund raising” described above. Three users are set to the account for “sharing”.

In this manner, setting of the accumulation account according to the present embodiment to “sharing” enables a fractional amount, an economization amount, or the like occurring due to individual bank transaction or card usage of a plurality of users (three) to be collectively reserved and accumulated into one accumulation account. Thus, more efficient reserving and asset building can be achieved.

Note that the number of users settable to the account for “sharing”, sharable attributes, and the like are not particularly limited. Thus, the account for sharing can be retained between users based on the number of users and attributes set by the financial institution.

### [Point Granting Corresponding to Degree of Achievement of Target Amount]

Next, point granting corresponding to the degree of achievement of the target amount in the fractional fund transfer and accumulation system 1 according to the present embodiment, will be specifically described.

As described above, in the present system, a predetermined point is granted, in accordance with the degree of achievement of the accumulated fund to the target amount set by the user, by the point value computation means 15 and the point management DB 27.

Specifically, gradual point granting in a process in which the user saves money or make investments for the target amount, enables urging to target achievement.

For the gradual point granting, for example, the point can be granted in accordance with stages in the degree of achievement, such as “10%->20%->30%->40%->50%-> . . . 100%” in the degree of achievement of the target amount.

This arrangement enables the user to be given an incentive for target achievement or pleasure or satisfaction due to granting and adding of the point, resulting in natural promotion and assistance for reserving achievement of the target amount.

The granted point can remain unavailable until the degree of achievement of the target amount attains 100%.

The granted point can be made only available for a specific shop or service (object set or assumed as the target).

Furthermore, the point accumulated until now can be set to be invalid when the target is changed. Thus, urging to target achievement can be performed without changing the object or the like to be the target.

The above arrangement enables retention of an incentive for achievement of 100% of the target amount or retention of continuous reserving and investment motivation.

The point to be granted can be changed in accordance with the target amount.

Granting a larger point to a larger target amount, such as “500 points” for “50% achievement” to “target amount: 100,000 yen” and “5,000 points” for “50% achievement” to “target amount: 1,000,000 yen”, enables stimulation and improvement of reserving motivation or investment sentiment of the user.

Note that, for investment, there is a possibility that fluctuation in fair value causes fluctuation in the degree of achievement. For example, if the degree of achievement falls below 50% on the next day after the degree of achievement attains 50%, the point granted on the previous day can be reduced for granting. In this case, making the granted point remain unavailable until the degree of achievement attains 100% causes no problem or the like even when addition and subtraction repeat in a process for target achievement.

For the point granting in the present system, a “continuation point” can be granted in accordance with the period during which saving or investment continues for achievement of the target amount.

In general, in consideration of the royalties of customers, improvement of engagement with customers, or the like on the service provider side, long-term service usage is better than short-term service usage because an increase in customer satisfaction, which leads to continuous and repetitive service usage.

For example, not only point or mile granting corresponding to a usage amount or a flight distance promotes usage, but also point granting corresponding to a continuous usage period enhances the relationship with customers.

Thus, also in the present system, point granting corresponding to a saving or investment continuous period is effective for performance of the point granting to the user.

For example, as illustrated in FIG. 16(a), after fractional saving starts in the present system, point granting can be performed such that the point (continuation point) increases as the continuous period lengthens, such as “10 points” at the first month and “20 points” at the second month.

This arrangement enables the user to be given a higher incentive for continuous usage to the fractional saving in the present system.

The “continuation point” as above may be changed in accordance with the target amount or the amount of money to be saved or invested, as illustrated in FIG. 16(b).

In the example illustrated in the figure, a larger “continuation point” is granted for a larger final target amount or a larger monthly target saving amount. This arrangement enables enhancement of the motivation and continuity of the user to reserving and investment.

FIG. 17(a) illustrates an exemplary display screen displaying the degree of achievement of the accumulated fund to the target amount, displayed by the display means 63 of the customer terminal 60. FIG. 17(b) illustrates an exemplary display screen notifying that the point corresponding to the degree of achievement to the target amount has been granted, similarly.

Note that, in the auto saving (e.g., fractional rules, economization rules, and change balance rules) in the present system, as described above, it can be considered that the monthly accumulated (transfer) amount is less than the monthly target amount (e.g., 10,000 yen).

In such a case, if the target is not attained, an arrangement can be made such that “the continuation point returns to the first month”. This arrangement enables the expectation that the user is motivated to attain the monthly target amount.

### [Automatic Order Processing Based on Target Achievement]

Next, the automatic order processing based on achievement of the target amount in the fractional fund transfer and accumulation system 1 according to the present embodiment, will be specifically described.

As described above, in the present system, in a case where the degree of achievement of the accumulated fund to the target amount attains the predetermined value, the automatic order processing is performed to a product or service being desired and considered for purchase, registered on the wish list (purchase information DB 28) set by the user, by the purchase order processing means 16 and the purchase information DB 28.

Specifically, in the present system, a plurality of products and services can be set on the wish list, and an article of which the amount of money is more than the target amount can be added and set.

An article to be automatically purchased is selected from a plurality of articles registered by setting.

For example, in a case where the progress (degree of achievement) of reserving is smooth, the user may be allowed to set a more expensive article as the article to be automatically purchased, and the target amount may be automatically changed.

The wish list can be shared between a plurality of users.

For example, a user A can set and register a private wish list and a wish list to be shared with a user B. In this case, similarly, the user B can set a private wish list and the wish list to be shared with the user A.

Specifically, in a case where a wish list is shared, first, the user A and the user B each add and set an individually desired product or the like onto a personal wish list. Then, an article to be purchased jointly is selected with a message function in the present system (application). The article to be purchased jointly can be set onto the sharing wish list in agreement between the user A and the user B. In this case, although the user A and the user B each can perform simple addition of an article onto the sharing wish list, setting of the automatic purchase requires mutual agreement between the user A and the user B.

Addition of an offer from the sales company, such as a retail store onto the wish list enables designation of an automatic order.

A plurality of offers can be added on the wish list for one goal (target amount).

In a case where a plurality of offers is registered on the wish list, an automatic order can be set to the plurality of offers if within the target amount.

For merchandise (e.g., a product or a service) having been added on the wish list as described above and having set with the automatic order, the purchase order processing means 16 performs the automatic order processing at the point in time the target amount is achieved.

Note that, for merchandise that varies in the amount of money after registered on the wish list, price is fixed at the point in time the merchandise is added onto the wish list. In a case where the amount of money at purchase is higher than the fixed price, an order can be made at the fixed price. In a case where the amount of money is lower than the fixed price, an order can be made at the lower price.

FIGS. 18 to 20 illustrate exemplary display screens for performance of purchase and order processing of a product, a service, or the like registered on the wish list displayed by the display means 63 of the customer terminal 60.

FIG. 18(a) illustrates a display screen displaying that the degree of achievement of the accumulated fund to the set target amount is “25%”.

FIGS. 18(b) and 18(c) illustrate display screens in a case where a product displayed on a display screen for “offer” selected on the screen of FIG. 18(a) is registered onto the wish list.

In the examples illustrated in the figures, in a case where the “goal (target amount)” for purchase of a product for “20,000 yen” on “the wife's birthday” is set, “shoulder bag made by CAACH: 19,800” is registered on the wish list (FIG. 18(b)), and furthermore “ON” is set such that the purchase order processing means 16 performs the automatic order processing in a case where the target amount is achieved (saved) (FIG. 18(c)).

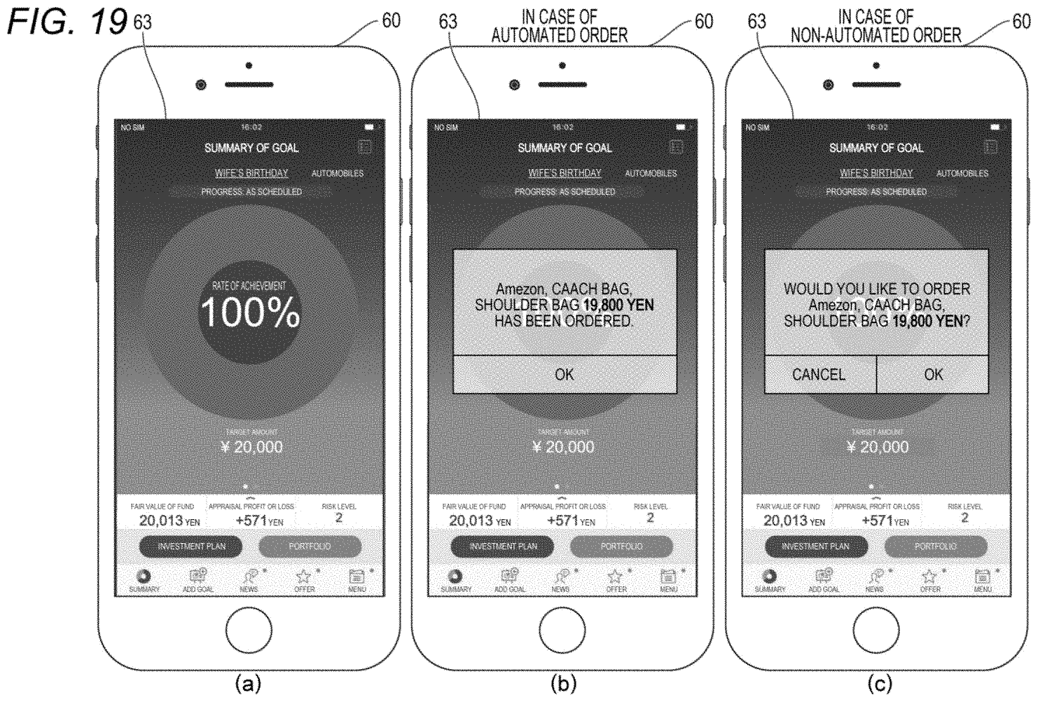

Following FIG. 18, FIG. 19(a) illustrates a display screen notifying and displaying the degree of achievement in a case where the set target amount (20,000 yen) is achieved.

Following FIG. 19(a), FIG. 19(b) illustrates a display screen notifying that order processing of a product or the like registered on the wish list has been performed, in a case where the “automatic order” is set at “ON” (FIG. 18(c)).

Similarly, FIG. 19(c) illustrates a display screen inquiring about order processing of a product or the like registered on the wish list, in a case where the “automatic order” is not set at “ON”.

As above, the present system enables the automatic order processing to a product, a service, or the like registered on the wish list, in accordance with the degree of achievement of the target amount of the user.

This arrangement enables an automatic order of a product or the like registered previously, for example, even when the user does not monitor the target amount or operate the order processing, and causes the order processing to be performed reliably even in a case where the user forgets to make an order or forgets that a product or the like has been registered.

Furthermore, the present system enables the user to previously decide a target achievement date, and enables display and recommendation of merchandise available for purchase with the amount of money saved until the target achievement date.

In this case, prediction of an amount of money that is likely to be attained on the target achievement date, from the status of saving or investment until now enables display and recommendation of merchandise available for purchase with the predicted amount.

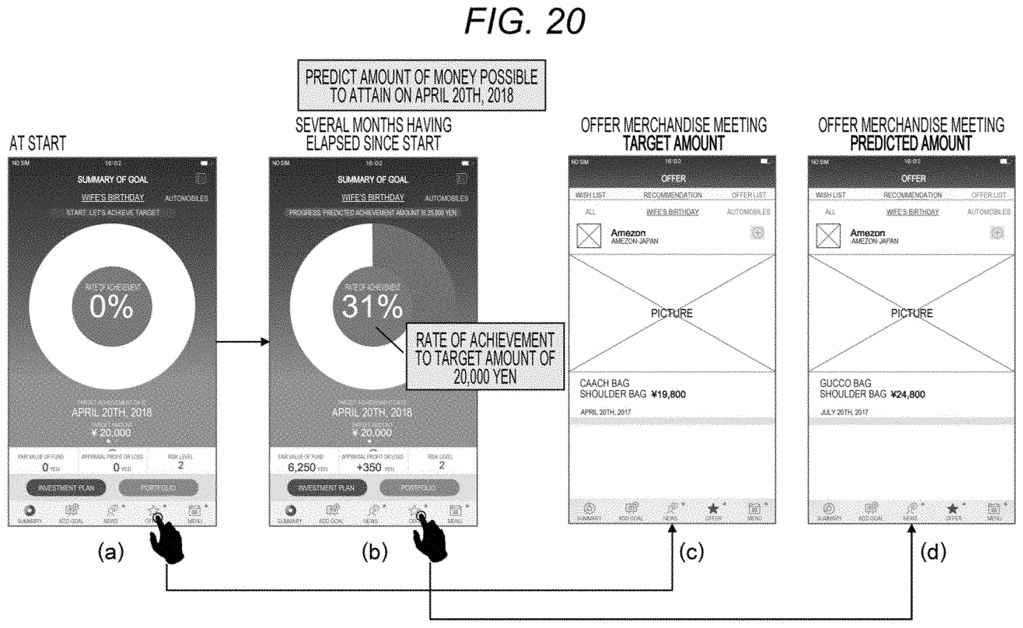

In the example illustrated in FIG. 20, for example, with “target amount: 20,000 yen” and “target achievement date: Apr. 20, 2018” set for “the wife's birthday”, the degree of achievement of the accumulated fund to the target amount is “0%” at the start of reserving in the present system (FIG. 20(a)).

As an initial desired purchase at the start, “shoulder bag made by CAACH: 19,800 yen” is registered on the wish list (FIG. 20(c)).

After that, the fractional saving progresses in the present system. At the stage that the degree of achievement of the accumulated fund to the target amount is “31%” (FIG. 20(b)), when an amount of money more than the target amount (20,000 yen) is predicted to be attained on the target achievement date (Apr. 20, 2018), from the status and progress of reserving until the stage, other merchandise available for purchase with the predicted attainment amount is displayed and recommended from products or the like which is the same in kind as the product or the like registered on the wish list.

Herein, a product “shoulder bag made by GUCCO: 24,800 yen” that is a product (shoulder bag) which is the same in kind as the product registered initially by the user and is more expensive than the registered product is exemplarily offered as “recommended” merchandise.

Such a predictable attainment amount or predictable attainment date to the target amount can be computed on the basis of the number of days and the reserved accumulated fund amount from the start of reserving in the present system to the current point in time.

On the basis of information regarding a product or the like registered on the wish list by the user and the predicted attainment amount, for example, the appropriate one or at least two products are searched and extracted from an Internet-shopping site and the appropriate information is transmitted and provided to the customer terminal 60 of the user, so that an offer of recommended merchandise can be achieved.

An application (program) having the functions of the target amount setting means 61, the fund calculation rule setting means 62, and the display means 63 is installed on the customer terminal 60. The customer terminal 60 having the application installed thereon and the fractional fund transfer and accumulation server 10 cooperate together, as necessary, with a product server that is a server at the company that provides products for registration onto the wish list, so that the function of the wish list can be provided.

Specifically, when the user makes a registration operation to the wish list on the application, the customer terminal 60 accesses the product server through the application. The product server transmits screen display information for searching. The user inputs a keyword or the like onto a screen for searching displayed on the customer terminal 60. The customer terminal 60 transmits the keyword or the like input to the product server. The product server performs searching with the keyword or the like received, and transmits extracted product information screen to the customer terminal 60. The customer terminal 60 displays the product information screen to the user, and receives a wish list registration instruction for a target product from the user. The customer terminal 60 transmits information regarding the target product at least to the fractional fund transfer and accumulation server 10. The fractional fund transfer and accumulation server 10 records, as information to be registered on the wish list, the received information regarding the target product.

Then, after registration of the target product on the wish list, order-placement processing can be performed with savings in the corresponding reserving account, in a case where the corresponding reserving amount is achieved or at an arbitrary timing of the user.

The order-placement processing is performed automatically on the basis of a predetermined condition or is performed by reception of approval of the user under a predetermined condition. In both cases, when the application of the customer terminal 60 places an order of the product registered on the wish list, the fractional fund transfer and accumulation server 10 receives the order placement from the customer terminal 60. Then, the order-placement processing can be performed to the product server through the fractional fund transfer and accumulation server 10.

Here, typically, the product server receives a product order from a browser displaying a home page (HP) for the product server or a product-server-purpose user application. However, for example, an application programming interface (API) for the order-placement processing is released for reception of order placement from an external device. Thus, use of the released API enables the customer terminal 60 to operate to place an order.

Specifically, when the customer terminal 60 sends an order-placement demand to the fractional fund transfer and accumulation server 10, the fractional fund transfer and accumulation server 10 reads information regarding the target product registered on the wish list and substitutes the information into an argument of the API, so that an order-placement request can be made to the product server through the API.

After the order-placement request, the customer terminal 60 receives an order-placement result from the product server through the fractional fund transfer and accumulation server 10, so that the order-placement result can be displayed to the user.

### [Sponsor Point]

Next, granting and adding of the sponsor point in the fractional fund transfer and accumulation system 1 according to the present embodiment will be specifically described.

As described above, in the present system, in a case where the sales company device 70 provides the predetermined sponsor point, the sponsor point is computed as a point value by the point value computation means 15 and the point management DB 27, so that the point value can be granted and added to the appropriate user.

Here, the “sponsor point” in the present system is provided to the users by the enterprise that distributes an offer from the sales company device 70 as described above (e.g., a sales company or a maker). The “sponsor point” is valuable information allocable to purchase of the products or services of the provider enterprise.

This is called the “sponsor point”. In the present system, each user can individually save the sponsor point.

The “sponsor point” is only available at purchase of the merchandise or services that the sponsor provides.

The point can be made into a limited-time point.

For the point, the number of points available may be determined for each product.

For example, for the point to be provided by a travel agency, the user sets an outline of desired “travel” (e.g., when, the number of overnights, areas, the number of people, and a budget (target accumulation amount)), so that an offer to be provided by the travel agency (refer to FIG. 21(a) to be described later) can be obtained.

Furthermore, on the basis of a product or the like registered on the wish list, a business operator that sells the target article can make a point offer or another business operator can make an offer while presenting an article similar to the registered product and a point to be granted.

As a method allowing the user to save the “sponsor point”, for example, the following operation and response enables obtainment and accumulation of the point from the customer terminal 60 through the Internet.
Browse an offer from the sponsor
Share the browsed offer through SNS
Add the offer onto the wish list
Respond to a questionnaire or the like from the sponsor

The sponsor point as above enables each enterprise that provides the point to carry out promotion, evocation, and the like for purchase of the enterprise's own products or services through the sponsor point as a medium.

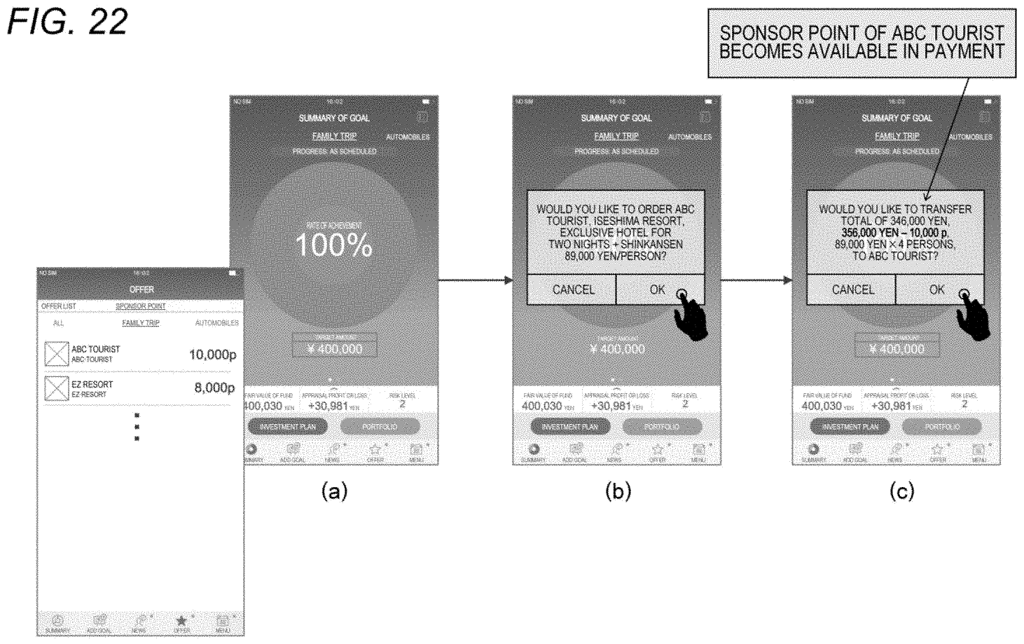

Specific examples of obtainment and usage of the sponsor point in the present system will be described with reference to FIGS. 21 and 22.

As illustrated in FIG. 21(a), first, the current degree of achievement to the target is “30%” with “target amount: 400,000 yen” set for “family trip” on the customer terminal 60. Then, reference and browsing to offer information causes display of pieces of offer information on a plurality of travel agencies, such as “ABC Tourist”, “EZ Resort”, and the like, as illustrated in FIG. 21(b).

The displayed pieces of offer information each can be registered on the wish list. A selection operation (e.g., a tap) of each piece of offer information enables movement to a WEB site provided and designated by the enterprise.

Then, the user selects and displays the offer information on each enterprise on the customer terminal 60, so that the sponsor point provided by the appropriate enterprise can be obtained.

Specifically, as illustrated in FIG. 21(c), when the offer information on each enterprise is selected on the customer terminal 60, an addition action of the point value of the sponsor point to be granted in association with the appropriate offer information is detected through the Internet (step 01). Then, the sponsor point is added and accumulated in the point management DB 27 (step 02). For the sponsor point to be stored and managed in the point management DB 27, information, such as predetermined enterprise information, the offer information, and the point value, is stored for each enterprise that provides the point value, in units of users.

For the sponsor point accumulated in the point management DB 27, the point value can be referred to and output in accordance with a reference demand or the like from the customer terminal 60 (step 03).

In the example illustrated in FIG. 21(c), as the current sponsor point granted to the user, the point value for each enterprise is output and displayed, such as “ABC Tourist: 150 points”, “EZ Resort: 230 points”, and the like.

Then, the sponsor point obtained and reserved as above can be allocated and used as expense for purchase of a product, a service, or the like of each of the appropriate enterprises.

In FIG. 22(a), at the point in time the target amount (400,000 yen) set by the user is achieved, the sponsor point that has been obtained by the user includes “ABC Tourist: 10,000 points”, “EZ Resort: 8,000 points”, and the like.

In this case, order processing of a travel plan provided by the “ABC Tourist” is performed by an input operation of the user to the customer terminal 60. Then, as illustrated in FIG. 22(b), a screen indicating whether the appropriate order processing is to be settled (“OK/Cancel”) is displayed. Selection of “OK” causes display of a screen indicating whether the retained sponsor point is to be allocated to payment of the order (“OK/Cancel”). Selection of “OK” causes the order processing to be settled.

In this manner, the user can use the sponsor point obtained by oneself, as part of cost for purchase of a desired product, service, or the like.

[Cooperation with Housekeeping Account-Book Software]

Next, cooperation with housekeeping account-book software in the fractional fund transfer and accumulation system 1 according to the present embodiment will be described.

In general, an application service called housekeeping account-book software is provided.

This kind of housekeeping account-book software installed on, for example, a smartphone, a PC, or a tablet terminal, provides a service enabling acquisition of, for example, a plurality of pieces of usage history information and balance information regarding a bank, a credit card, a receipt, and the like, automatic generation of housekeeping account-book information, and classification and output of the housekeeping account-book information for each item, such as utility costs and food expenses. For example, “Money Forward ME” (registered trademark) has been known.

Note that use of the housekeeping account-book software enables the user to input usage history information manually simultaneously with classification setting for each item.

In a case where such housekeeping account-book software is implemented and used in the customer terminal 60 of the user, the present system enables performance of fractional saving in cooperation with the housekeeping account-book software.

Specifically, in a case where the account balance has surplus, the housekeeping account-book software enables a fraction to be saved at intervals, such as monthly, weekly, or daily.

On the housekeeping account-book software, for example, usage breakdown information regarding a credit card is imported. In addition, OCR information regarding a receipt and manual input information are imported as housekeeping account-book targets. Thus, the fractional saving in the present system can be performed, on the basis of the pieces of information. The import is performed with Web scraping and a reference API.

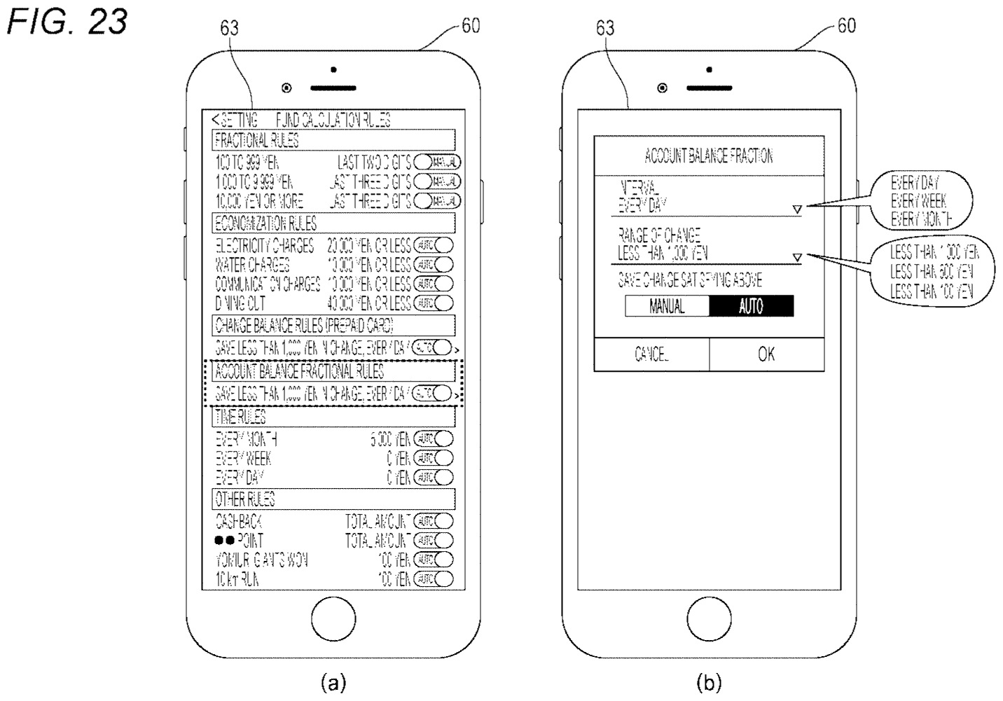

FIG. 23 illustrates setting screens for the “fund calculation rules” in the present system, similarly to FIGS. 7 and 8.

Herein, as one of the “fund calculation rules”, “account balance fractional rules” cooperating with the housekeeping account-book software can be selected and set.

Specifically, as illustrated in FIG. 23(b), as the “account balance fractional rules”, the respective items of “interval” and “range of change” can be selected and set, and “manual” or “auto” in fund transfer mode can be selected and set for the set “account balance fractional rules”.

This arrangement enables a predetermined fractional portion from the balance of the deposit amount in the bank account to result in a principal for saving or investment, similarly to the fractional saving with the prepaid card described above (refer to FIG. 8).

For example, “every day”, “every week”, or “every month” can be set as the interval for calculation of the fraction (change portion) of the account balance. The calculation of the fraction can be performed at the end of the day (e.g., at 0 a.m.) for the “every day”, at the end of the week (e.g., at 0 a.m. on the Sunday) for the “every week”, and at the end of the month (e.g., at 0 a.m. on the last day of the month) for the “every month”.

As the range of the fraction (change), “less than 1,000 yen”, “less than 500 yen”, and “less than 100 yen” are provided. Specifically, in a case where the balance of the prepaid card at the end of a day (week or month) is “1,734 yen”, “734 yen” results in the change with the “range” set to the “less than 1,000 yen”, “234 yen” results in the change with the “range” set to the “less than 500 yen”, and “34 yen” results in the change with the “range” set to the “less than 100 yen”. Then, the amount of money of the change is allocated as the transfer fund to accumulate and save.

In this manner, the present system enables accumulation and reserving of the fractional portion of the balance in the bank account of the user, as the fractional saving, in cooperation with the existing housekeeping account-book software.

As described above, according to the present embodiment, the user sets arbitrary fund calculation rules to the fractional fund transfer and accumulation server 10, so that the fractional amount computed on the basis of user's daily payment or the like can be transferred as the reserving amount to the reserving fund as the target.

In particular, the plurality of different rules of the fractional rules, the economization rules, the change balance rules, the time rules, and the other rules are settable as the fund calculation rules, so that the user can effortlessly carry out efficient and continuous reserving.

The rule setting enabling the user to be urged to suppression of spending or the idea of economization, such as economization of utility costs or dining out and a reward to a favorite event or oneself enables natural encouragement and evocation of active reserving action.

Therefore, in giving particularly personal asset management advice or the like, a service suitable for reserving of the purchase fund for a financial product can be provided while flexibly responding to various needs, consumption patterns, life patterns, or the like of personal users.

In this manner, according to the embodiment of the fractional fund transfer and accumulation system according to the present invention, flexible responses can be made to various needs of personal users. Thus, financial technology (Fin-Tech) enabling suggestions to personal investors or the like who consider specific and planned asset management or investment planning that meets particularly daily life cycles or the like can be achieved.

Note that, according to the present embodiment described above, the display screens output and displayed on the customer terminal 60 side, are displayed by display means having a relatively small screen, such as the display of a smartphone or a mobile phone (FIGS. 6 to 10, 12, and 14 to 22).

Note that the display screens to be generated and displayed in the present invention may be displayed by display means having a relatively large screen, such as the display means of a PC or a tablet terminal as a matter of course.

The preferred embodiment of the present invention has been described above, but the present invention is not limited to the embodiment described above. Needless to say, various changes can be made without departing from the scope of the present invention.

For example, according to the embodiment described above, the “fractional rules”, the “economization rules”, the “change balance rules”, the “time rules”, and the “other rules” are provided as the “fund calculation rules” according to the present invention. However, these rules are exemplary for the “fund calculation rules”. Thus, the “fund calculation rules” are not limited to these. That is, the “fund calculation rules” according to the present invention can adopt part or all of the “fractional rules”, the “economization rules”, the “change balance rules”, the “time rules”, and the “other rules” described above. In addition, addition or replacement of a rule different from the rules can be performed. Any rule, condition, or the like allowing the user to be stimulated into reserving consciousness or investment motivation for efficient and continuous reserving can be adopted as the “fund calculation rules” according to the present invention.

According to the embodiment described above, the fractional fund transfer and accumulation server and the financial institution devices are separately independently provided. However, these may be provided as a single (shared) device or system.

In that case, the fractional fund transfer and accumulation system according to the present invention is achieved as part of the financial institution device installed in each financial institution.

According to the embodiment described above, the bank is described as a specific exemplary financial institution having the fund account and the accumulation account according to the present invention. However, the financial institution is not particularly limited to the bank.

Examples of the financial institution having the deduction account to be used for user's daily consumption or settlement may include a post office, a trust bank, a credit association, and a credit union in addition to the bank.

Examples of the financial institution having the accumulation account as the fund transfer destination may include the post office, the trust bank, the credit association, and the credit union as described above, and a securities company and an investment trust company.

The financial institution having the fund account (e.g., the bank) and the financial institution having the accumulation account (e.g., the securities company) may be different. In that case, the transfer fund can be moved by remittance or transfer from the financial institution having the fund account to the financial institution having the accumulation account. Here, according to the embodiment described above, the description has been given, in which the fund transfer instruction means 12 transmits the predetermined fund transfer instruction information to the financial institution device 40, on the basis of the fund calculation result information stored in the fund calculation result DB 24, at the predetermined timing. Examples of the predetermined timing include the timing the record to be processed is stored in the fund calculation result DB 24, and predetermined periodic timing, such as daily and monthly. In particular, for the periodic timing, the total amount of money of a plurality of records combined is remitted or transferred. Thus, low-cost management can be performed in a case where bank commission is required. For example, some financial institutions make commission free for inter-branch transfer. Thus, transfer may be performed at the timing of addition of a record if bank commission is free, and processing may be performed at the periodic timing if bank commission is not free.

The display screens displayable and browsable on the customer terminal described in the embodiment above are exemplary. Needless to say, the screens can be arbitrarily set and changed in configuration and content.

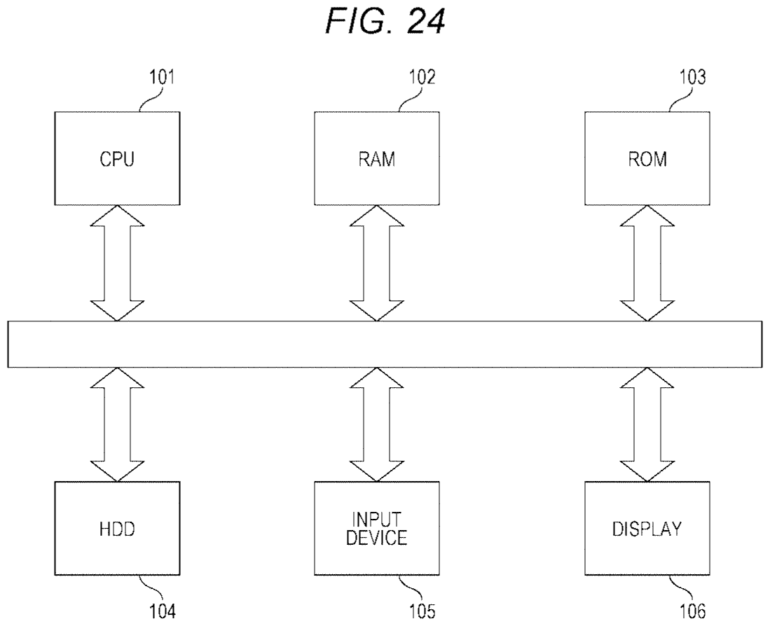

FIG. 24 illustrates an exemplary hardware configuration of the fractional fund transfer and accumulation server 10 and the customer terminal 60 described in the embodiment described above, including a CPU 101, a RAM 102, a ROM 103, a HDD 104, an input device 105, and a display device 106. The constituent elements are connected through a system bus, and exchange data through the system bus. The central processing unit (CPU) 101 that is also called a central processor. The CPU 101 performs central processing of the computer to perform control of each device and calculation/processing of data. The random access memory (RAM) 102 that is a kind of memory device enables deletion and rewriting of data. The read only memory (ROM) 103 that is a kind of memory device including a semiconductor or the like enables one-time data writing at manufacturing and only reading of recorded data during usage. The hard disk drive (HDD) 104 is an auxiliary storage device that records and reads information, with a property of magnetic material. The input device 105 is used for user to issue an operation instruction to the computer or to input characters or the like, and specifically includes a keyboard and a mouse. The display device 106 is, for example, a liquid crystal display, and may have a touch panel function. In addition, a communication function not illustrated is provided. Thus, the communication function enables communication with another terminal. Note that the customer terminal 60 may include a mobile terminal, namely, a smartphone or a tablet.

Although the operation in which the transfer processing is performed on the basis of the transfer information generated according to the set saving rules and then savings are accumulated in the account for reserving, has been described, an instruction of canceling only a saving act selected by the user from the already accumulated saving acts can be issued. In this case, transfer processing of the amount of money equivalent to the target saving act is performed from the amount of money accumulated in the account for reserving to the account for assets. Referring to the fund transfer result DB 25 illustrated in FIG. 13, in a case where the saving-performed records stored in the fund transfer result DB 25 are displayed as the past saving acts on the user terminal, the user selects a record to be canceled, namely, a saving act to be canceled from the displayed saving-performed records. A fund transfer instruction of transferring the transferred transfer amount of the selected record from the account for reserving to the account for assets is transmitted to the financial institution device. After the transmission, the fund transfer status of the selected record is updated to “canceled”. Here, instead of the updating to the “canceled”, processing of removing the selected record may be performed. In a case where a plurality of saving-performed records is selected to be canceled, a fund transfer instruction generated every selected record can be transmitted to the financial institution device. Alternatively, one fund transfer instruction generated with the total amount of the respective transfer amounts of the selected records can be transmitted to the financial institution device.

In a case where the user notifies the system that the saving requires stopping or that the target amount is attained, the accumulated savings for saving until now can be transferred to the account designated by the user (the account for assets, another account in the same financial institution, or an account in a different financial institution). In a case where the saving requires stopping or in a case where the target amount is attained, the records stored in the fund transfer result DB 25 can be removed. However, the storage can be retained as the past saving. For example, the records may be retained by default and a target record may be removed by an instruction of the user. Here, desirably, the past saving is displayed so as to be distinguished from the current saving being performed. For display of the contents of record, typically, only the current saving being performed may be displayed, and the past saving may be displayed only in a case where a demand for display of the past saving is received from the user.

In a case where a plurality of pieces of saving is performed, in some cases, first saving and second saving require integrating. In this case, when an account is provided for each piece of saving, an instruction for fund-transferring the amount of money reserved in the account for saving for the first saving from the account for saving for the first saving to the account for saving for the second saving can be generated so as to be transmitted to the financial institution device. In addition, the records recorded on the fund transfer result DB 25, recorded in linking with the first saving, can be changed so as to be linked with the second saving. As another configuration, reserving is performed in a shared account for saving between the plurality of pieces of saving because no individual account is provided for each piece of saving. In this case, although the account for saving requires no transferring, processing of linking the records recorded on the fund transfer result DB 25, recorded in linking with the first saving, with the second saving should be performed.

In a case where no fund to be reserved is left in the account for funds when a predetermined reserving act is attempted, the reserving results in failure. Detection of reserving failure in such a case where no fund is left can be performed in the system in the following examples:
a case where the fractional fund transfer and accumulation server 10 grasps the amount of money in the account for assets retained in the financial institution device at the timing that a transfer instruction is generated and then the amount of money in the account for assets is less than the transfer amount of the transfer instruction.
a case where the fractional fund transfer and accumulation server 10 inquires the balance of the account for assets from the financial institution device at the timing that a transfer instruction is generated and then the amount of money in the account for assets is less than the transfer amount of the transfer instruction.
a case where the fractional fund transfer and accumulation server 10 generates a transfer instruction and transmits the transfer instruction to the financial institution device, and then the financial institution device performs transferring according to the transfer instruction, resulting in failure, and notifies the fractional fund transfer and accumulation server 10 of the transfer failure.

In such a case where the reserving failure is detected, an operation of notifying the saver of an answer to the reserving failure, an operation of attempting the same transferring again on another day, or an operation of notifying the saver of an answer to the reserving failure, skipping a saving operation this time, and performing the next saving operation at the next timing may be performed.

For [Sharing Account Setting] according to the embodiment, the mechanism in which a plurality of users sets one accumulation account and the plurality of users performs sharing saving, has been described. Even in a case where the plurality of users performs the sharing saving, each user may perform saving into the account for saving retained by the user, namely, the users each may perform rule setting for saving operation. Savings may be accumulated in each account, and then the total of the respective amounts of money saved by the users to the sharing saving may be displayed as the saving amount.

### INDUSTRIAL APPLICABILITY

The present invention is suitably available, for example, as a system for assisting business in which a financial institution or the like gives an investor a piece of advice or a suggestion according to investment.

### REFERENCE SIGNS LIST

1 fractional fund transfer and accumulation system
10 fractional fund transfer and accumulation server
11 fund calculation means
12 fund transfer instruction means
13 accumulated fund information generation means
14 target amount achievement computation means
15 point value computation means
16 purchase order processing means
17 offer information transmission means
20 fractional fund transfer and accumulation DWH
21 target amount DB
22 fund calculation rule DB
23 account information DB
24 fund calculation result DB
25 fund transfer result DB
26 accumulated fund DB
27 point management DB
28 purchase information DB
30 financial institution device (credit card company)
40 financial institution device (bank)
50 financial institution device (prepaid card company)
60 customer terminal
70 sales company device
101 CPU
102 RAM
103 ROM
104 HDD
105 input device
106 display device (display)

1. A fractional fund transfer and accumulation system which transfers, based on rule information set in accordance with an input operation of a customer, a fund from a fund account of the customer to a predetermined accumulation account to accumulate a predetermined target amount, the fractional fund transfer and accumulation system comprising:
target amount storage means for storing predetermined target amount information set in accordance with an input operation;
fund calculation rule storage means for storing predetermined fund calculation rule information set in accordance with an input operation;
account information storage means for storing account information regarding the fund account of the customer;
fund calculation means for calculating, based on the fund calculation rule information, a transfer amount of a transfer fund to be transferred from the fund account of the customer to the predetermined accumulation account;
fund transfer instruction means for transmitting, based on the calculated transfer amount, predetermined fund transfer instruction information to a predetermined financial institution device that manages the fund account of the customer;
accumulated fund information generation means for generating predetermined accumulated fund information including the transfer amount;
accumulated fund storage means for storing the accumulated fund information; and
target amount achievement computation means for computing, based on the accumulated fund information and the target amount information, a predetermined degree of achievement of an accumulated fund to the target amount.

2. The fractional fund transfer and accumulation system according to claim 1, wherein
the account information storage means receives and stores, from a predetermined financial institution device that manages a deposit fund account of a prepaid card of the customer, account information including a deposit amount of the prepaid card of the customer, and
the fund calculation means computes, as the transfer amount, a fractional amount indicated by a difference between the deposit amount of the prepaid card of the customer and a predetermined set amount.

3. The fractional fund transfer and accumulation system according to claim 1, further comprising:
point value computation means for computing a predetermined point value to be granted to the customer; and
point value storage means for storing predetermined point information including the point value, wherein
the point value computation means computes the predetermined point value, based on the degree of achievement computed by the target amount achievement computation means.

4. The fractional fund transfer and accumulation system according to any one of claim 1, further comprising:
purchase information storage means for storing predetermined purchase information regarding purchase desired by the customer, based on the accumulated fund; and
purchase order processing means for performing, in a case where the degree of achievement of the accumulated fund to the target amount has a predetermined value, predetermined order processing, based on the purchase information.

5. The fractional fund transfer and accumulation system according to claim 3, further comprising:
offer information transmission means for receiving predetermined offer information including a point value grantable to the customer, from a sales company device installed in a sales company that provides a predetermined purchase, the offer information being transmitted browsably to a customer terminal operable by the customer, wherein the point value storage means stores, as the point value,
the point value included in the offer information selected by the customer terminal in accordance with an input operation.
